(19) United States
(12) Patent Application Publication
(10) Pub. No.: US 2024/0113416 A1
(43) Pub. Date: Apr. 4, 2024

(54) ANTENNA MODULE AND ELECTRONIC DEVICE

(71) Applicant: GUANGDONG OPPO MOBILE TELECOMMUNICATIONS CORP., LTD., Dongguan (CN)

(72) Inventors: Jiacheng ZHAO, Dongguan (CN); Xiaopu WU, Dongguan (CN)

(73) Assignee: GUANGDONG OPPO MOBILE TELECOMMUNICATIONS CORP., LTD., Dongguan (CN)

(21) Appl. No.: 18/503,144

(22) Filed: Nov. 6, 2023

Related U.S. Application Data
(63) Continuation of application No. PCT/CN2022/091426, filed on May 7, 2022.

(30) Foreign Application Priority Data
Jun. 30, 2021 (CN) 202110743205.9

(51) Int. Cl. H01Q 1/24; H01Q 5/335

(52) U.S. Cl. CPC H01Q 1/243; H01Q 5/335

(57) ABSTRACT

An antenna module and an electronic device are provided. A radiator includes a first radiator and a second radiator, and a coupling gap is between the first radiator and the second radiator. A first grounding end of the first radiator and a second grounding terminal of the second radiator are both electrically connected to a reference ground. A first feed system is used for exciting the radiator to receive and transmit a first electromagnetic wave signal. The first electromagnetic wave signal includes at least one of a GPS signal, and a mobile communication signal of a first frequency band. A second feed system is used for exciting the radiator to receive and transmit a second electromagnetic wave signal. The second electromagnetic wave signal includes a Wi-Fi signal. A third feed system is used for exciting the radiator to receive and transmit a third electromagnetic wave signal.

### CROSS-REFERENCE TO RELATED APPLICATIONS

The present application is a continuation of International Patent Application No. PCT/CN2022/091426, filed May 7, 2022, which claims priority to Chinese Patent Application No. 202110743205.9, filed Jun. 30, 2021, both of which are herein incorporated by reference in their entirety.

### TECHNICAL FIELD

The present disclosure relates to the technical field of communication, and in particular to an antenna module and an electronic device.

### BACKGROUND

With the development of communication technology, the popularity of electronic devices with communication functions is higher and higher, and the requirement of network access speed is higher and higher. Accordingly, how to improve a coverage rate of electromagnetic wave signals becomes a technical problem to be solved.

### SUMMARY OF THE DISCLOSURE

In a first aspect, the present disclosure provides an antenna module. The antenna module includes a radiator, a first feed system, a second feed system, and a third feed system.

The radiator includes a first radiator and a second radiator. The first radiator includes a first grounding end, a first coupling end, a first feed point, and a second feed point. The first feed point and the second feed point are disposed between the first grounding end and the first coupling end at an interval. The second radiator includes a second coupling end, a second grounding end and a third feed point between the second coupling end and the second grounding end. A coupling gap is defined between the first coupling end and the second coupling end. The first grounding end and the second grounding end are electrically connected to a reference ground.

The first feed system is electrically connected to the first feed point. The first feed system is configured to excite the radiator to receive and transmit a first electromagnetic wave signal. The first electromagnetic wave signal includes at least one of a GPS signal and a mobile communication signal of a first frequency band.

The second feed system is electrically connected to the second feed point. The second feed system is configured for exciting the radiator to receive and transmit a second electromagnetic wave signal, and the second electromagnetic wave signal includes a Wi-Fi signal.

The third feed system is electrically connected to the third feed point. The third feed system is configured to excite the radiator to receive and transmit a third electromagnetic wave signal. The third electromagnetic wave signal includes a mobile communication signal of a second frequency band, and a minimum frequency of the second frequency band is greater than a maximum frequency of the first frequency band.

In a second aspect, the present disclosure provides an electronic device including the above-mentioned antenna module.

### BRIEF DESCRIPTION OF THE DRAWINGS

FIG. 1 is a structural schematic view of an electronic device according to a first embodiment of the present disclosure.

FIG. 2 is a partially exploded schematic view of the electronic device shown in FIG. 1.

FIG. 3 is a schematic view of an equivalent circuit of an antenna module according to the first embodiment of the present disclosure.

FIG. 4 is an equivalent circuit schematic view illustrating a first feed system receiving and transmitting a first electromagnetic wave signal according to the first embodiment of the present disclosure.

FIG. 5 is a graph illustrating S-parameters of the first feed system shown in FIG. 4 receiving and transmitting the first electromagnetic wave signal.

FIG. 6 is an equivalent circuit view of a first adjusting circuit disposed on a first radiator according to the first embodiment of the present disclosure.

FIG. 7 is a structural schematic view illustrating parallel connection of a first adjusting circuit and a first matching circuit according to the first embodiment of the present disclosure.

FIG. 8 is a structural schematic view of the first matching circuit according to the first embodiment of the present disclosure.

FIG. 9 is a structural schematic view illustrating a series connection formed by the first adjusting circuit and the first matching circuit according to the first embodiment of the present disclosure.

FIG. 10 is a graph illustrating S-parameters of the first adjusting circuit via adjusting the first electromagnetic wave signal according to the first embodiment of the present disclosure.

FIG. 11 is a structural schematic view of a first filter circuit according to an embodiment of the present disclosure.

FIG. 12 is a structural schematic view of a second filter circuit according to an embodiment of the present disclosure.

FIG. 13 is a structural schematic view of a third filter circuit according to an embodiment of the present disclosure.

FIG. 14 is a structural schematic view of a fourth filter circuit according to an embodiment of the present disclosure.

FIG. 15 is a structural schematic view of a fifth filter circuit according to an embodiment of the present disclosure.

FIG. 16 is a structural schematic view of a sixth filter circuit according to an embodiment of the present disclosure.

FIG. 17 is a structural schematic view of a seventh filter circuit according to an embodiment of the present disclosure.

FIG. 18 is a structural schematic view of an eighth filter circuit according to an embodiment of the present disclosure.

FIG. 19 is a structural schematic view of the antenna module with a first band-pass circuit shown in FIG. 3.

FIG. 20 is an equivalent circuit view of a third feed system shown in FIG. 19 receiving and transmitting a third electromagnetic wave signal in the antenna module.

FIG. 21 is a graph illustrating S-parameters of the third feed system shown in FIG. 20 transmitting and receiving the third electromagnetic wave signal.

FIG. 22 is a structural schematic view of the third matching circuit according to an embodiment of the present disclosure.

FIG. 23 is a structural schematic view of the antenna module shown in FIG. 3 with a second band-pass circuit.

FIG. 24 is a structural schematic view of the first matching circuit provided with the first band-pass circuit according to the first embodiment of the present disclosure.

FIG. 25 is an equivalent circuit schematic view of a second feed system shown in FIG. 23 for transmitting and receiving a second electromagnetic wave signal.

FIG. 26 is a graph illustrating S-parameters of the second feed system shown in FIG. 25 receiving and transmitting the second electromagnetic wave signal.

FIG. 27 is a structural schematic view of a second matching circuit according to the first embodiment of the present disclosure.

FIG. 28 is a graph illustrating S-parameters of the first feed system transmitting and receiving the first electromagnetic wave signal, the second feed system transmitting and receiving the second electromagnetic wave signal, and the third feed system transmitting and receiving the third electromagnetic wave signal according to the first embodiment of the present disclosure.

FIG. 29 is a graph illustrating isolation degrees of a first signal source, a second signal source, and a third signal source according to the first embodiment of the present disclosure.

FIG. 30 is an equivalent circuit schematic view of the antenna module according to a second embodiment of the present disclosure.

FIG. 31 is an equivalent circuit schematic view of the antenna module shown in FIG. 30 with a fourth matching circuit.

FIG. 32 is an equivalent circuit schematic view of the third feed system in the antenna module shown in FIG. 31 receiving and transmitting the third electromagnetic wave signal.

FIG. 33 is a graph illustrating S-parameters of the third feed system in the antenna module shown in FIG. 32 receiving and transmitting the third electromagnetic wave signal.

FIG. 34 is a first circuit schematic view illustrating the third matching circuit and the fourth matching circuit shown in FIG. 32.

FIG. 35 is a second circuit schematic view illustrating the third matching circuit and the fourth matching circuit shown in FIG. 32.

FIG. 36 is a third circuit schematic view illustrating the third matching circuit and the fourth matching circuit shown in FIG. 32.

FIG. 37 is a graph illustrating S parameters of the first feed system transmitting and receiving the first electromagnetic wave signal, the second feed system transmitting and receiving the second electromagnetic wave signal, and the third feed system transmitting and receiving the third electromagnetic wave signal according to the second embodiment of the present disclosure.

FIG. 38 is a graph illustrating isolation degrees of the first signal source, the second signal source and the third signal source according to the second embodiment of the present disclosure.

FIG. 39 is a graph illustrating efficiency of the antenna module with and without a third radiator according to an embodiment of the present disclosure.

FIG. 40 is an equivalent circuit schematic view of the antenna module according to a third embodiment of the present disclosure.

FIG. 41 is an equivalent circuit view of the third feed system in the antenna module shown in FIG. 40 receiving and transmitting the third electromagnetic wave signal.

FIG. 42 is a graph illustrating S parameters of the third feed system in the antenna module shown in FIG. 41 receiving and transmitting the third electromagnetic wave signal.

FIG. 43 is a structural schematic view illustrating a third band-pass circuit in the antenna module shown in FIG. 40.

FIG. 44 is a graph illustrating S parameters of the first feed system transmitting and receiving the first electromagnetic wave signal, the second feed system transmitting and receiving the second electromagnetic wave signal, and the third feed system transmitting and receiving the third electromagnetic wave signal according to the third embodiment of the present disclosure.

FIG. 45 is a first structural schematic view of the second matching circuit provided with the third band-pass circuit in the antenna module shown in FIG. 40.

FIG. 46 is a second structural schematic view of the second matching circuit provided with the third band-pass circuit in the antenna module shown in FIG. 40.

FIG. 47 is a graph illustrating isolation degrees of the first signal source, the second signal source, and the third signal source according to the third embodiment of the present disclosure.

FIG. 48 is a graph illustrating efficiency of the antenna module with and without the third band-pass circuit according to an embodiment of the present disclosure.

FIG. 49 is a structural schematic view illustrating the first radiator, a second radiator, and the third radiator disposed in the electronic device according to an embodiment of the present disclosure.

### DETAILED DESCRIPTION

The technical solutions in some embodiments of the present disclosure may be clearly and completely described in conjunction with accompanying drawings in some embodiments of the present disclosure. Obviously, the described embodiments are only a part of the embodiments of the present disclosure, and not all embodiments. The reference to “embodiments” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure may be combined with other embodiments.

The present disclosure provides an antenna module and an electronic device both capable of improving a coverage rate of electromagnetic wave signals.

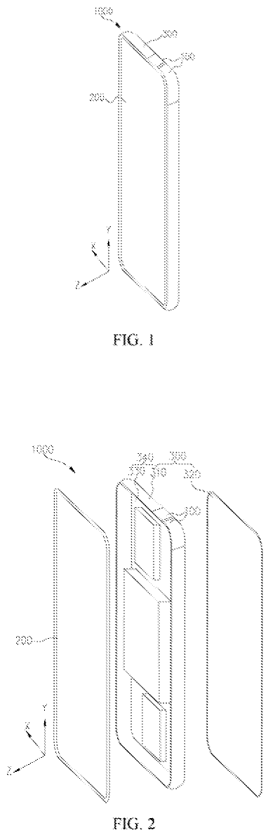

As illustrated in FIG. 1, FIG. 1 is a structural schematic view of an electronic device 1000 according to a first embodiment of the present disclosure. The electronic device 1000 includes an antenna module 100, and the antenna module 100 is configured to receive and transmit an electromagnetic wave signal. In the present disclosure, a position of the antenna module 100 on the electronic device 1000 is not specifically limited. FIG. 1 only shows an example of the electronic device 1000. The electronic device 1000 further includes a display screen 200 and a housing 300 that are connected to each other in a covering manner. The antenna module 100 may be disposed inside the housing 300 of the electronic device 1000, or may be partially integrated with the housing 300, or may be partially disposed outside the housing 300. In FIG. 1, a radiator of the antenna module 100 is integrated with the housing 300. The antenna module 100 may further be disposed on a retractable component of the electronic device 1000. That is, at least part of the antenna module 100 may extend out of the electronic device 1000 along with the retractable component of the electronic device 1000, and retract into the electronic device 1000 along with the retractable component. Alternatively, an overall length of the antenna module 100 extends with an extension of the retractable component of electronic device 1000.

The electronic device 1000 includes, but is not limit to, a device capable of transmitting and receiving the electromagnetic wave signal, such as a phone, a television, a tablet computer, a mobile phone, a camera, a personal computer, a laptop, a vehicle-mounted device, a headset, a watch, a wearable device, a base station, a vehicle-mounted radar, a Customer Premise Equipment (CPE), or the like. In the present disclosure, the electronic device 1000 being a mobile phone is taken as an example, and other devices may refer to the detailed description in the present disclosure.

For illustrative purposes, a view angle of the electronic device 1000 in FIG. 1 is taken as a reference, a width direction of the electronic device 1000 is defined as an X-axis direction, a length direction of the electronic device 1000 is defined as a Y-axis direction, a thickness direction of the electronic device 1000 is defined as a Z-axis direction. The X-axis direction, the Y-axis direction and the Z-axis direction are perpendicular to each other, and a direction indicated by an arrow is a positive direction.

As illustrated in FIG. 2, the housing 300 includes a frame 310 and a rear cover 320. A middle plate 330 is formed in the frame 310 by injection molding. A plurality of mounting grooves for mounting various electronic devices are formed on the middle plate 330. The middle plate 330 and the frame 310 together form a middle frame 340 of the electronic device 1000. After the display screen 200, the middle frame 340, and the rear cover 320 are assembled together, each of two sides of the middle frame 340 form an accommodating space. One side (such as a rear side) of the frame 310 surrounds and is connected to a periphery of the rear cover 320, and the other side (such as a front side) of the frame 310 surrounds and is connected to a periphery of the display screen 200. The electronic device 1000 further includes a device disposed in the accommodating space and capable of implementing basic functions of the mobile phone, such as a battery, a camera, a microphone, a receiver, a speaker, a face recognition module, a fingerprint recognition module, or the like, which is not be described in detail in the present embodiment.

The antenna module 100 provided by the present disclosure is specifically described in conjunction with the accompanying drawings. Of course, the antenna module 100 provided by the present disclosure includes but is not limited to the following embodiments.

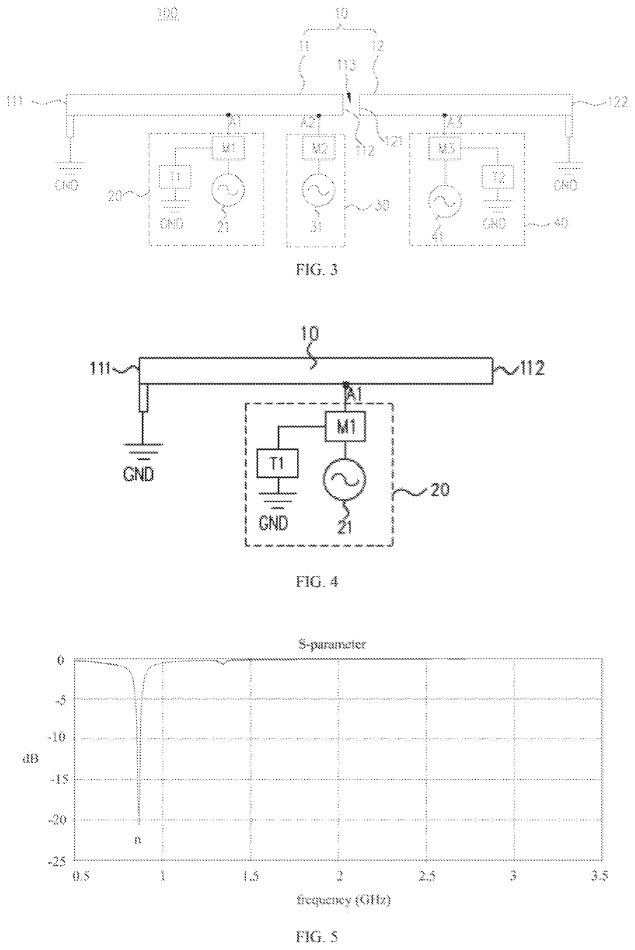

As illustrated in FIG. 3, the antenna module 100 at least includes a radiator 10, a first feed system 20, a second feed system 30, and a third feed system 40.

The radiator 10 at least includes a first radiator 11 and a second radiator 12.

As illustrated in FIG. 3, the first radiator 11 includes a first grounding end 111 and a first coupling end 112, and a first feed point A1 and a second feed point A2 located between the first grounding end 111 and the first coupling end 112 and arranged at an interval. The first feed point A1 is located between the second feed point A2 and the first grounding end 111. The first radiator 11 shown in FIG. 3 is merely an example, and a shape of the first radiator 11 provided by the present disclosure cannot be limited. The first grounding end 111 and the first coupling end 112 are two opposite ends of the first radiator 11 in a straight-line strip shape. In some embodiments, the first radiator 11 is bent, the first grounding end 111 and the first coupling end 112 may not be opposite to each other along a straight-line direction, but the first grounding end 111 and the first coupling end 112 are still two ends of the first radiator 11.

As illustrated in FIG. 3, the second radiator 12 includes a second coupling end 121 and a second grounding end 122, and a third feed point A3 located between the second coupling end 121 and the second grounding end 122. A coupling slot 113 exists between the second coupling end 121 and the first coupling end 112. The first radiator 11 and the second radiator 12 may generate capacitive coupling through the coupling slot 113. The second radiator 12 shown in FIG. 3 is merely an example, and a shape of the second radiator 12 provided by the present disclosure cannot be limited. The second coupling end 121 and the second grounding end 122 are two opposite ends of the second radiator 12. In some embodiments, the first radiator 11 and the second radiator 12 may be arranged along a straight line or approximately along the straight line (that is, there is a small tolerance in a design process). In some embodiments, the first radiator 11 and the second radiator 12 may also be arranged in a staggered manner in an extending direction to form an avoidance space, etc.

As illustrated in FIG. 3, the first coupling end 112 and the second coupling end 121 are opposite to each other and spaced apart from each other. The coupling slot 113 is a broken slot between the first radiator 11 and the second radiator 12. For example, a width of the coupling slot 113 may be in a range from 0.5 mm to 2 mm, but not limited to this size. The first radiator 11 and the second radiator 12 may be regarded as two parts of the radiator 10 separated by the coupling slot 113.

The first radiator 11 and the second radiator 12 are capacitively coupled to each other through the coupling slot 113. The “Capacitively coupled” means: an electric field is generated between the first radiator 11 and the second radiator 12, a signal of the first radiator 11 may be transmitted to the second radiator 12 by the electric field, and a signal of the second radiator 12 may be transmitted to the first radiator 11 by the electric field, so that the first radiator 11 and the second radiator 12 may be electrically conducted even in a state where the first radiator 11 is not in direct contact with or is not directly connected to the second radiator 12.

The shapes and structures of the first radiator 11 and the second radiator 12 are not specifically limited. The shapes of the first radiator 11 and the second radiator 12 include, but are not limited to, a strip shape, a sheet shape, a rod shape, a coating, a film, or the like. In response to both the first radiator 11 and the second radiator 12 are strip-shaped, extending tracks of the first radiator 11 and the second radiator 12 in the present disclosure are not limited, so that the first radiator 11 and the second radiator 12 may extend along the extending tracks, such as straight lines, curves, multi-section bending, or the like. The radiator 10 may be a line with uniform width on the extending track, or may be a strip with different widths, such as a gradually changed width, a widened area, or the like.

In some embodiments, the radiator 10 is made of a conductive material, and a specific material include, but is not limited to, a metal, such as a copper, a gold, and a silver; or an alloy of the copper, the gold, and the silver; or an alloy of the copper, the gold, the silver, and other materials; a graphene, or a conductive material formed by the graphene and other materials; an oxide conductive material, such as indium tin oxide; a mixed material formed by carbon nanotubes and a polymer, or the like.

Both the first grounding end 111 and the second grounding end 122 are electrically connected to a reference ground GND. The reference ground GND in the present disclosure may be a reference ground GND system. The reference ground GND system may be a structure, or a plurality of structures mutually independent and mutually electrically connected to each other. The first grounding end 111 and the second grounding end 122 may be electrically connected to different positions of one reference ground GND structure, respectively. Alternatively, the first grounding end 111 and the second grounding end 122 may be electrically connected to two structures that are mutually electrically connected and are mutually independent in physical structure, respectively. The electrical connection mode includes, but is not limited to, direct welding, or indirect electrical connection through a coaxial line, a microstrip line, a conductive elastic sheet, a conductive adhesive, or the like.

The reference ground GND provided by the present disclosure may be disposed inside the antenna module 100, or disposed outside the antenna module 100 (such as, in the electronic device 1000 or in the electronic element of the electronic device 1000). In some embodiments, the antenna module 100 itself has the reference ground GND. The specific form of the reference ground GND includes, but is not limited to, a metal conductive plate, a metal conductive layer formed in a hard circuit board or a flexible circuit board, or the like. In response to the antenna module 100 is disposed in the electronic device 1000, the reference ground GND of the antenna module 100 is electrically connected to the reference ground of the electronic device 1000. In some embodiments, the antenna module 100 itself does not have the reference ground GND, the first grounding end 111 and second grounding end 122 of the antenna module 100 are directly or indirectly electrically connected to the reference ground of the electronic device 1000 or the reference ground of the electronic element in the electronic device 1000 through a conductive element. In the present embodiment, the antenna module 100 is disposed on the electronic device 1000, the electronic device 1000 is the mobile phone, and the reference ground of the electronic device 1000 is a magnesium-aluminum metal alloy plate of the middle plate 330 in the mobile phone. The first grounding end 111 and the second grounding end 122 of the antenna module 100 are electrically connected to the magnesium-aluminum metal alloy plate. The other structures of subsequent antenna module 100 that are electrically connected to the reference ground GND may refer to any one of the above embodiments for electrically connecting to the reference ground GND.

One end of the first feed system 20 is electrically connected to the first feed point A1 of the first radiator 11. The first feed system 20 is configured to excite the radiator 10 to receive and transmit a first electromagnetic wave signal. The first electromagnetic wave signal includes at least one of a GPS signal, a mobile communication signal of a first frequency band, or the like. In other words, the first electromagnetic wave signal includes a GPS frequency band, such as a GPS-L5 frequency band. Alternatively, the first electromagnetic wave signal includes the mobile communication signal of the first frequency band, wherein the first frequency band includes but is not limited to a low frequency (LB) frequency band. Alternatively, the first electromagnetic wave signal includes the mobile communication signal of the first frequency band and the GPS frequency band. In some embodiments, the first feed system 20 includes a first matching circuit M1 and a first signal source 21. One end of the first signal source 21 is electrically connected to one end of the first matching circuit M1, and the other end of the first matching circuit M1 is electrically connected to the first feed point A1 of the first radiator 11. The first signal source 21 includes, but is not limited to, a radio frequency transceiver chip or a feed part electrically connected to the radio frequency transceiver chip. The first matching circuit M1 may include a capacitor, an inductor, or the like. The first matching circuit M1 further includes a switching element. A specific structure and a function of the first matching circuit M1 may be described in detail later.

The second feed system 30 is electrically connected to the second feed point A2 of the first radiator 11. The second feed system 30 is configured to excite the radiator 10 to transmit and receive a second electromagnetic wave signal. The second electromagnetic wave signal includes a Wi-Fi signal. The first feed system 20 and the second feed system 30 are feed systems with different functions (or different communication protocols). For example, the first feed system 20 includes a GPS chip and a mobile communication chip (such as a cellular baseband chip). The second feed system 30 includes a Wi-Fi chip to control the transceiving of the Wi-Fi signal. The second feed system 30 includes a filter circuit configured to pass the Wi-Fi signal.

In some embodiments, both the first feed system 20 and the second feed system 30 are electrically connected to the first radiator 11. The first radiator 11 contributes to the transceiving of the first electromagnetic wave signal and the transceiving of the second electromagnetic wave signal. The second feed system 30 has a structure similar to that of the first feed system 20. The second feed system 30 includes a second matching circuit M2 and a second signal source 31. One end of the second signal source 31 is electrically connected to one end of the second matching circuit M2, and the other end of the second matching circuit M2 is electrically connected to the second feed point A2 of the first radiator 11. The second signal source 31 includes, but is not limited to, the radio frequency transceiver chip or the feed part electrically connected to the radio frequency transceiver chip. The second matching circuit M2 may include the capacitor device, the inductor device, or the like. The second matching circuit M2 further includes the switching device. A specific structure and a function of the second matching circuit M2 may be described in detail later.

The third feed system 40 is electrically connected to the third feed point A3 of the second radiator 12. The third feed system 40 is configured to excite the radiator 10 to receive and transmit a third electromagnetic wave signal. The third electromagnetic wave signal includes a mobile communication signal in a second frequency band (the mobile communication signal may be a cellular mobile network signal). The minimum frequency of the second frequency band is greater than the maximum frequency of the first frequency band. For example, the first frequency band is in a range of (K1-K2) and the second frequency band is in a range of (K3-K4), and a value of K3 is greater than a value of K2.

In some embodiments, both the first feed system 20 and the third feed system 40 include mobile communication chips, to control the transceiving of the mobile communication signals. A filter circuit of the third feed system 40 is different from a filter circuit of the first feed system 20. For example, the filter circuit of the first feed system 20 is configured to pass the mobile communication signal of the first frequency band, the filter circuit of the third feed system 40 is configured to pass the mobile communication signal of the third frequency band. Thus, the first feed system 20 and the third feed system 40 control the radiator 10 to transmit and receive the first electromagnetic wave signal and the third electromagnetic wave signal with different frequency bands, so as to realize the coverage of different frequency bands of the mobile communication signal and increase the coverage of full frequency band of the mobile communication signal.

In some embodiments, the third feed system 40 includes a third matching circuit M3 and a third signal source 41. One end of the third signal source 41 is electrically connected to one end of the third matching circuit M3, and the other end of the third matching circuit M3 is electrically connected to the third feed point A3 of the second radiator 12. The third signal source 41 includes, but is not limited to, the radio frequency transceiving chip or the feed part electrically connected to the radio frequency transceiving chip. The third matching circuit M3 may include the capacitor device, the inductor device, or the like. The third matching circuit M3 further includes the switching device. A specific structure and a function of the third matching circuit M3 may be described in detail later.

Generally, frequency bands of the electromagnetic wave signal correspond to lengths of the radiator one by one. In order to implement the mobile communication signal of the first frequency band, the mobile communication signal of the second frequency band, the GPS signal and the Wi-Fi signal of the present disclosure, at least four radiators need to be disposed. The effective electrical lengths of the four radiators are respectively in one-to-one correspondence with the frequency bands of the four signals. The four radiators are all disposed in the electronic device (such as the mobile phone) with a limited internal space, a large space is occupied, for example, a low-frequency antenna needs to occupy more than half of the space of a mobile phone frame. Thus, the functions of receiving and transmitting the GPS signals, the Wi-Fi signals, and the mobile communication signals of different frequency bands are not integrated in the electronic device.

In the present disclosure, the first radiator 11 and the second radiator 12 are capacitively coupled, the first feed system 20 and the second feed system 30 are electrically connected to the first radiator 11, and the third feed system 40 is electrically connected to the second radiator 12. Thus, the first feed system 20, the second feed system 30, and the third feed system 40 multiplex the first radiator 11, and the second feed system 30 and the third feed system 40 multiplex the first radiator 11 and the second radiator 12. On one hand, by means of a common aperture technology of multiple different feed systems, an antenna space utilization rate is improved, a space occupied by the antenna module 100 is small, and a stacking size of the antenna module 100 on the electronic device 1000 is small. On the other hand, the mobile communication signal of the first frequency band, the mobile communication signal of the second frequency band, the GPS signal, and the Wi-Fi signal may be covered, it is also possible to reduce the number and size of the radiators 10 as much as possible. In addition, in the process that the first radiator 11 and the second radiator 12 are multiplexed by the second feed system 30 and the third feed system 40, multi-mode simultaneous working is achieved, the bandwidth of the antenna is widened, and therefore the coverage rate of the antenna module 100 in the full frequency band of the Wi-Fi signals and the mobile communication signals is improved.

The antenna module 100 provided by the present disclosure may simultaneously support transceiving of the first electromagnetic wave signal, the second electromagnetic wave signal, and the third electromagnetic wave signal. The specific frequency bands of the first electromagnetic wave signal, the second electromagnetic wave signal and the third electromagnetic wave signal are not specifically limited. The first electromagnetic wave signal includes, but is not limited to, at least one of the GPS-L5 frequency band, a mobile communication signal with a frequency of less than 1000 MHz, and the like. The second electromagnetic wave signal includes, but is not limited to, at least one of Wi-Fi 5G (e.g., 5150-5850 MHz), Wi-Fi 6E (e.g., 5.925 GHz-7.125 GHz) signals, etc. The third electromagnetic wave signal includes, but is not limited to, a mobile communication signal having a frequency greater than or equal to 1000 MHz and less than or equal to 6000 MHz. The mobile communication signal in the first electromagnetic wave signal and the third electromagnetic wave signal includes at least one of a 4G mobile communication signal and/or a 5G mobile communication signal.

In some embodiments, the antenna module 100 may only load the 4G mobile communication signal, or only load the 5G mobile communication signal, or simultaneously load the 4G mobile communication signal and the 5G mobile communication signal. That is, LTE NR Double Connect (ENDC) of a 4G radio access network and a 5G-NR is implemented. In response to the antenna module 100 individually loads the 4G mobile communication signal or the 5G mobile communication signal, the frequency band received and transmitted by the antenna module 100 includes multiple carriers (carriers are radio waves of a specific frequency) aggregated. That is, Carrier Aggregation (CA) is implemented, so as to increase a transmission bandwidth, improve throughput, and increase a signal transmission rate.

In the present disclosure, the 4G mobile communication signal or the 5G mobile communication signal with the frequency less than 1000 MHz is defined as a Low-Band (LB) frequency band. The 4G mobile communication signal or the 5G mobile communication signal with a frequency greater than or equal to 1000 MHz and less than or equal to 3000 MHz is defined as a Middle-High Band (MHB) frequency band. The 4G mobile communication signal or the 5G mobile communication signal with a frequency greater than 3000 MHz and less than or equal to 6000 MHz is defined as an Ultra-High Band (UHB) frequency band.

The first frequency band and the second frequency band are not specifically limited in the present disclosure. In the present disclosure, the first frequency band is the LB frequency band, and the second frequency band is an MHB+UHB frequency band. The MHB+UHB frequency band is a combined frequency band formed by the MHB frequency band and the UHB frequency band, i.e., greater than or equal to 1000 MHz and less than or equal to 6000 MHz. In some embodiments, both the first frequency band and the second frequency band are the LB frequency bands, or both the first frequency band and the second frequency band are the MHB frequency bands, or both the first frequency band and the second frequency band are the UHB frequency bands, or the first frequency band is the LB frequency band and the second frequency band is the MHB frequency band, or the first frequency band is the LB frequency band and the second frequency band is the UHB frequency band, or the first frequency band is the MHB frequency band and the second frequency band is the UHB frequency band.

In the present disclosure, the mobile communication signal of the first frequency band is disposed to be the LB frequency band, and the mobile communication signal of the second frequency band is disposed to be the MHB+UHB frequency band. Thus, the first feed system 20 and the third feed system 40 may excite the radiator 10 to cover the low-frequency band, the middle-high frequency band and the ultra-high frequency band of the mobile communication signal. The coverage of the antenna module 100 in different frequency bands is improved. Subsequently, a position of the first frequency band in the LB frequency band may be adjusted by combining an adjusting circuit (including a switch selection circuit or a variable capacitor) that is disposed in the first feed system 20 and the third feed system 40 and may adjust the movement of the frequency band. A position of the second frequency band in the MHB+UHB frequency band may be adjusted to increase the frequency band covered by the antenna module 100, thereby improving the coverage rate of all frequency bands of the low-frequency band, the middle frequency band, the high frequency band, and the ultrahigh frequency bands of the mobile communication signal.

The antenna principles of the first feed system 20, the second feed system 30, and the third feed system 40 during operation are illustrated in conjunction with the accompanying drawings. The following implementation takes the first electromagnetic wave signal being the LB frequency band, the second electromagnetic wave signal being the Wi-Fi 5G/6E frequency band, and the third electromagnetic wave signal being the MHB+UHB frequency band as examples.

The antenna principle of the first feed system 20 during operation is exemplified below in conjunction with the accompanying drawings.

As illustrated in FIG. 4, FIG. 4 is an antenna schematic view of the first feed system 20 during operation. The first feed system 20 excites the first radiator 11 to generate at least one resonance mode, and the frequency band supported by the resonance mode is in the LB frequency band.

As illustrated in FIG. 5, the current corresponding to a resonance mode n generated by the first feed system 20 exciting the first radiator 11 is mainly distributed between the first grounding end 111 and the first coupling end 112 of the first radiator 11. The current density generated by the excitation signal of the first feed system 20 on the radiator 10 is mainly distributed between the first grounding end 111 and the first coupling end 112 of the first radiator 11. The terms “the current corresponding to the resonance mode generated by the first feed system 20 exciting the radiator 10 is mainly distributed between the first grounding end 111 and the first coupling end 112 of the first radiator 11” mean that the stronger current is distributed between the first grounding end 111 and the first coupling end 112 of the first radiator 11. It is not excluded that due to the coupling effect of the first radiator 11 and the second radiator 12, a small amount of current generated by the excitation signal of the first feed system 20 on the first radiator 11 is distributed on the second radiator 12. The present disclosure does not limit a direction of a resonant current.

The resonance mode is characterized in that the antenna module 100 has higher electromagnetic wave receiving and transmitting efficiency at and near the resonance frequency. The resonance frequency is a resonance frequency of the resonance mode. The resonance frequency and its vicinity form the frequency band supported or covered by the resonance mode. In some embodiments, in a return loss curve, an absolute value of a return loss value being greater than or equal to 5 dB (just for example, it cannot be used as a limitation on a return loss value with higher efficiency in the present disclosure.) is set as a reference value with high electromagnetic wave transmission and reception efficiency. A set of frequencies with the absolute value of the return loss value greater than or equal to 5 dB in the resonance mode is taken as the frequency band supported by the resonance mode.

In some embodiments, the resonance mode generated by the first feed system 20 exciting the first radiator 11 is that the resonant current mainly operates in a ¼ wavelength mode from the first grounding end 111 to the first coupling end 112 of the first radiator 11. The ¼ wavelength mode may be understood to mean that an effective electrical length from the first grounding end 111 to the first coupling end 112 of the first radiator 11 is approximately ¼ times a medium wavelength (wavelength in the medium) corresponding to a center frequency of the resonance mode. This description is used for understanding terminology, but not limit the length from the first grounding end 111 to the first coupling end 112 of the first radiator 11. In other implementations, the resonance mode generated by the first feed system 20 exciting the first radiator 11 may also be a higher-order mode where the resonant current mainly operates on the first radiator 11, such as a ½ wavelength mode, a ¾ wavelength mode, etc.

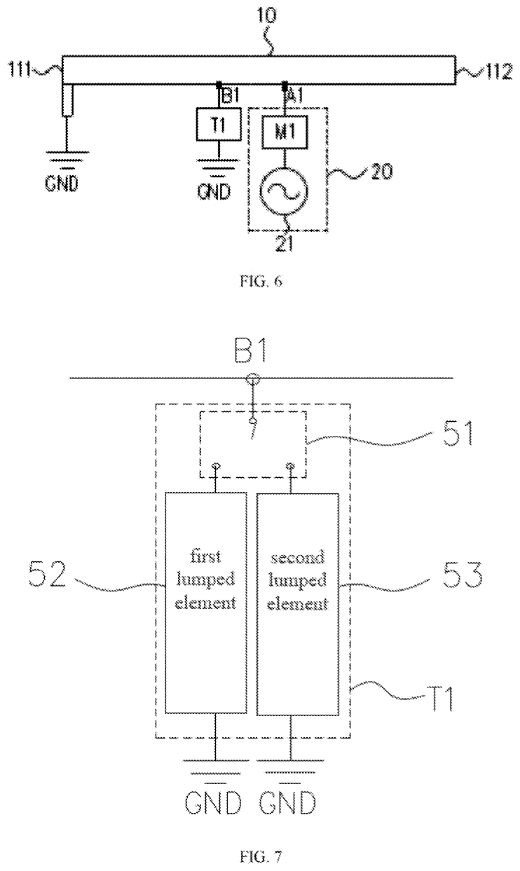

In some embodiments, as illustrated in FIG. 6, the antenna module 100 further includes a first adjusting circuit T1. One end of the first adjusting circuit T1 is electrically connected to the first radiator 11, and the other end of the first adjusting circuit T1 is electrically connected to the reference ground GND. The first adjusting circuit T1 is configured to adjust the frequency band of the first electromagnetic wave signal. In the present disclosure, a position where the first adjusting circuit T1 is electrically connected to the first radiator 11 is not specifically described. In some embodiments, a first adjusting point B1 for electrically connecting the first adjusting circuit T1 is defined between the first grounding end 111 and the first coupling end 112 of the first radiator 11.

In some embodiments, the first adjusting point B1 is close to a current strong point on the first radiator 11. For example, a distance between the first adjusting point B1 and the first grounding end 111 is greater than a distance between the first adjusting point B1 and the first coupling end 112, so that the first adjusting circuit T1 may adjust the position of the frequency band supported by the first radiator 11 in a certain range.

In some embodiments, the first adjusting circuit T1 includes at least one of the variable capacitor and a plurality of switch selection circuits. The switch selection circuit includes at least one of a combination of the switch and the inductor, a combination of the switch and the capacitor, a combination of the switch, the inductor and the capacitor. The first adjusting circuit T1 switches different impedances to ground by controlling the on-off of the switch or adjusting the variable capacitor, thereby achieving switching between different frequency bands.

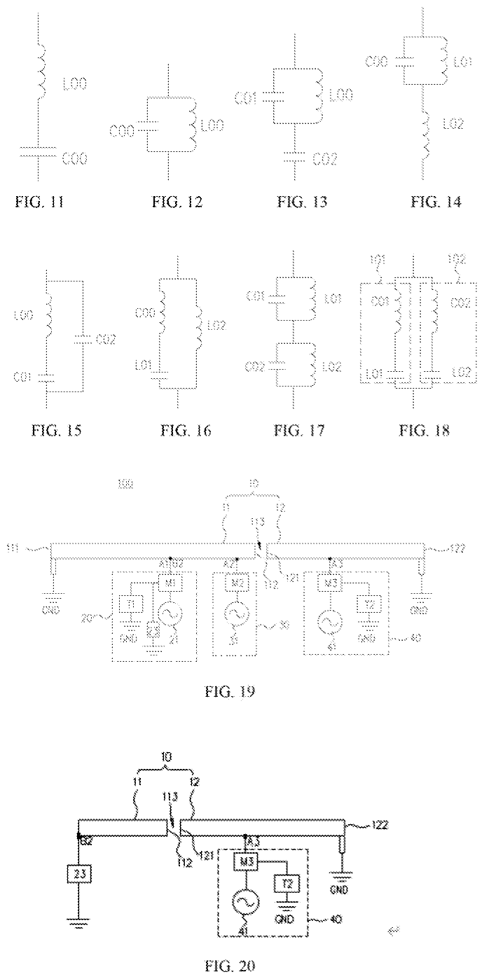

As illustrated in FIG. 7, the first adjusting circuit T1 includes a single-pole double-throw switch 51, a first lumped element 52 electrically connected to the ground reference GND, and a second lumped element 53 electrically connected to the ground reference GND. Each of the first lumped element 52 and the second lumped element 53 includes the inductor, the capacitor, or the combination of the inductor and the capacitor. The combination of the capacitors may be the combination shown in FIG. 11 to FIG. 18.

The first lumped element 52 and the second lumped element 53 have different impedances to ground for the first electromagnetic wave signal (i.e., LB frequency band). The single-pole double-throw switch 51 and the two lumped elements 52, 53 are only for illustration, and the present disclosure is not limited to the two lumped elements and the single-pole double-throw switches, and may be two independent switches. In addition, the number of the lumped elements may be three, four, etc.

The antenna module 100 further includes a controller (not shown). The controller is electrically connected to the first adjusting circuit T1. The controller controls the switch of the first adjusting circuit T1 to be switched and electrically connected to different lumped elements, so as to achieve different impedances to ground for the first electromagnetic wave signal (i.e., the LB frequency band), further achieving a position adjustment for the frequency band of the first electromagnetic wave signal (i.e., LB frequency band). For example, the smaller the switched inductance value, the more the frequency band of the first electromagnetic wave signal (i.e., the LB frequency band) shifts towards the high-frequency end; the larger the switched capacitance value, the more the frequency band of the first electromagnetic wave signal (i.e., the LB frequency band) shifts towards the low-frequency end.

In other implementations, the first adjusting point B1 is the first feed point A1, and one end of the first adjusting circuit T1 is electrically connected to the first feed point A1, so as to reduce electrical connection points on the first radiator 11, so that in actual products, the number of electrical connection element, such as elastic sheets, may be reduced.

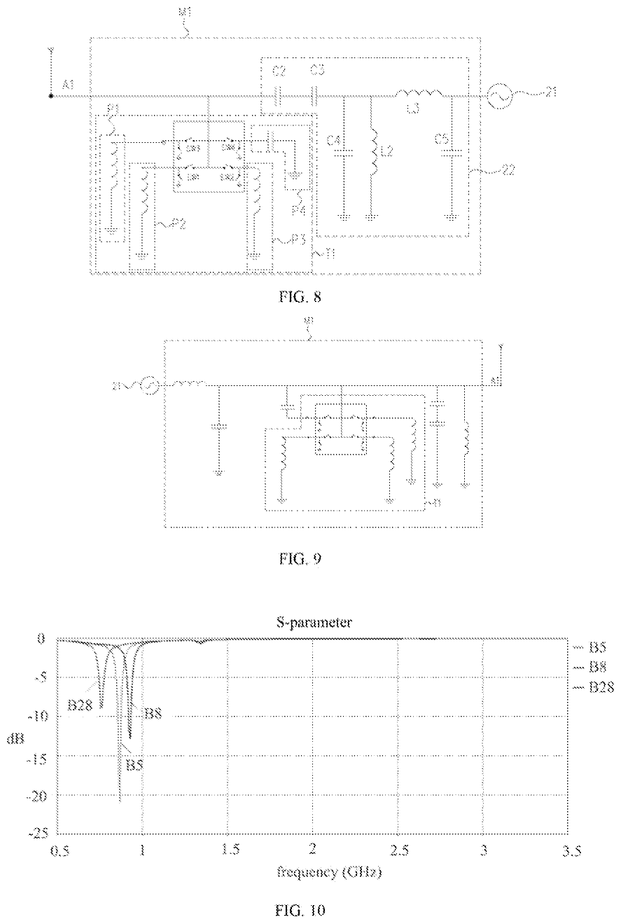

Further, as illustrated in FIG. 4, the first adjusting circuit T1 is a part of the first matching circuit M1 (as also illustrated in FIG. 8). Thus, the first adjusting circuit T1 may be manufactured in the manufacturing process of the first matching circuit M1. Compared to the independent setting of the first adjusting circuit T1, it may reduce the number of the electrical connection points on the first radiator 11, thereby achieving centralized setting of the circuit, and achieving functional multiplexing of the first adjusting circuit T1 in the first matching circuit M1. For example, some capacitors or inductors in the first adjusting circuit T1 may also be configured for frequency selection or tuning in the first matching circuit M1, or the first adjusting circuit T1 may be used as a serial circuit or a parallel circuit of the first matching circuit M1.

As illustrated in FIG. 8, FIG. 8 is a schematic view of the first adjusting circuit T1 as the parallel circuit of the first matching circuit M1.

One end of the first adjusting circuit T1 is electrically connected to the first feed point A1, and the other end of the first adjusting circuit T1 is electrically connected to the reference ground GND. For example, the first adjusting circuit T1 includes four switches (SW1-SW4) and four adjusting branches (P1-P4). Each switch is electrically connected to one adjusting branch. The first adjusting branch P1, the second adjusting branch P2, and the third adjusting branch P3 are inductors electrically connected to the reference ground GND. The different adjusting branches have different inductance values, and the fourth adjusting branch P4 is the capacitor electrically connected to the reference ground GND. Above description is only an example of the first adjusting circuit T1, and each adjusting branch may also refer to the combination of resonant elements shown in FIG. 11 to FIG. 18.

As illustrated in FIG. 8, the first matching circuit M1 further includes a first tuning circuit 22. One end of the first tuning circuit 22 is electrically connected to the first feed point A1, and the other end of the first tuning circuit 22 is electrically connected to the first signal source 21. The first tuning circuit 22 is configured to tune the resonance frequency point and the frequency band width of the first electromagnetic wave signal.

For example, as illustrated in FIG. 8, The first tuning circuit 22 includes a second capacitor C2 (a first capacitor C1 is introduced and explained later), a third capacitor C3, a fourth capacitor C4, a fifth capacitor C5, a second inductor L2 (a first inductor L1 is introduced and explained later) and a third inductor L3. One end of the second capacitor C2 is electrically connected to the first feed point A1, and the other end of the second capacitor C2 is electrically connected to one end of the third capacitor C3. The other end of the third capacitor C3 is electrically connected to one end of the fourth capacitor C4, one end of the second inductor L2, and one end of the third inductor L3. The other end of the fourth capacitor C4 is electrically connected to the reference ground GND, and the other end of the second inductor L2 is electrically connected to the reference ground GND. The other end of the third inductor L3 is electrically connected to the first signal source 21 and one end of the fifth capacitor C5. The other end of the fifth capacitor C5 is electrically connected to the reference ground GND. Above description is only an example of the first tuning circuit 22. The resonant element in the first tuning circuit 22 may also refer to the combination of the resonant elements shown in FIG. 11 to FIG. 18.

Further, the first matching circuit M1 further includes a circuit having a band-stop characteristic for the second electromagnetic wave signal and the third electromagnetic wave signal (MHB+UHB frequency band), thereby filtering the second electromagnetic wave signal and the third electromagnetic wave signal (MHB+UHB frequency band), while having no influence on the first electromagnetic wave signal, so that the first feed system 20 excites the first radiator 11 to receive and transmit the first electromagnetic wave signal.

As illustrated in FIG. 9, FIG. 9 is a schematic view of the first adjusting circuit T1 as the series circuit of the first matching circuit M1. The first adjusting circuit T1 is a part of the first matching circuit M1. The first adjusting circuit T1 includes four switches. The three switches are electrically connected to the three adjusting branches respectively, and the fourth switch allows the three switches to be in series with the capacitor in the first matching circuit M1. The three adjusting branches are three grounding inductors with different inductance values. The four switches are switched to form different combinations of capacitor and inductor (i.e., LC resonant circuit), so as to form different impedance to ground for the first electromagnetic wave signal (i.e., LB frequency band). Thus, the first electromagnetic wave signal (i.e., LB frequency band) is shifted towards the low frequency end or towards the high frequency end.

As illustrated in FIG. 10, FIG. 10 is a schematic view of switching of the first adjusting circuit T1 to different frequency bands of the first electromagnetic wave signal. In FIG. 10, frequency bands B5, B8, and B28 are taken as examples. The frequency bands B5, B8, and B28 are only examples of the first electromagnetic wave signal that may be shifted towards the high frequency end or towards the low frequency end in the low frequency range. It is not limited that the first electromagnetic wave signal is the B5 frequency band, the B8 frequency band, or the B28 frequency band. In some embodiments of the present disclosure, the first electromagnetic wave signal may also be adjusted to cover a B20 frequency band. As shown in FIG. 10, by disposing the first adjusting circuit T1, the first electromagnetic wave signal may be shifted towards the high frequency end or the low frequency end in the low frequency range.

The first adjusting circuit T1 is disposed on the first radiator 11 to allow the first adjusting circuit T1 to switch the first electromagnetic wave signal in different frequency bands, so as to improve the coverage rate in the low-frequency band. Thus, the antenna module 100 may support several application frequency bands of the low-frequency band, and further may support use frequency bands of different places. The antenna module 100 and the electronic device 1000 including the antenna module 100 may be used in the world and may support the mobile communication signals of different operators.

In response to the first adjusting circuit T1 is disposed in the first matching circuit M1, other parts of the first matching circuit M1 may further include the above-mentioned variable capacitor, the plurality of switch selection circuits, etc., to realize switching. In response to the first matching circuit M1 does not include the above-mentioned first adjusting circuit T1, the first matching circuit M1 may include the variable capacitor and the plurality of switch selection circuits for switching the second matching circuit M2. The third matching circuit M3 may also include the variable capacitor and the plurality of switch selection circuits for switching.

In the present disclosure, the matching circuit (e.g., at least one of the first matching circuit M1, the second matching circuit M2, and the third matching circuit M3) has a frequency-selective filter circuit electrically connected to the reference ground GND, so as to achieve broadband matching of the antenna module 100 and high isolation degrees. The frequency-selective filter circuit is composed of a resonator or a plurality of resonator, and the resonator is the capacitor or the inductor. The number of the resonator is not limited. Every two of the resonators may be combined in series or in parallel to form different resonant circuits. Several combinations of two resonator, three resonators, and four resonators are described in conjunction with the accompanying drawings. The following examples cannot limit the frequency-selective filter circuit as the following resonance circuit. Taking the frequency-selective filter circuit of the first matching circuit M1 as an example, the frequency-selective filter circuits of the second matching circuit M2 and the third matching circuit M3 may adjust the number and electrical connection mode of the resonators according to actual needs.

As illustrated in FIG. 11, the frequency-selective filter circuit of the first matching circuit M1 includes a band-pass circuit formed by connecting an inductor L00 and a capacitor C00 in series.

As illustrated in FIG. 12, the frequency-selective filter circuit of the first matching circuit M1 includes a band-stop circuit formed by connecting the inductor L00 and the capacitor C00 in parallel.

As illustrated in FIG. 13, the frequency-selecting filter circuit of the first matching circuit M1 includes a band-pass or a band-stop circuit formed by the inductor L00, a capacitor C01, and a capacitor C02. The inductor L00 is connected in parallel with the capacitor C01, and the capacitor C02 is electrically connected to a node where the inductor L00 is electrically connected to the capacitor C01.

As illustrated in FIG. 14, the frequency-selecting filter circuit of the first matching circuit M1 includes a band-pass or band-stop circuit formed by the capacitor C00, an inductor L01, and an inductor L02. The capacitor C00 is connected in parallel with the inductor L01, and the inductor L02 is electrically connected to a node where the capacitor C00 is electrically connected to the inductor L01.

As illustrated in FIG. 15, the frequency-selecting filter circuit of the first matching circuit M1 includes a band-pass or band-stop circuit formed by the inductor L00, the capacitor C01, and the capacitor C02. The inductor L00 is connected in series with the capacitor C01. One end of the capacitor C02 is electrically connected to a first end of the inductor L00 that is not connected to the capacitor C01, and the other end of the capacitor C02 is electrically connected to an end of the capacitor C01 that is not connected to the inductor L00.

As illustrated in FIG. 16, the frequency-selecting filter circuit of the first matching circuit M1 includes a band-pass or band-stop circuit formed by the capacitor C00, the inductor L01 and the inductor L02. The capacitor C00 is connected in series with the inductor L01. One end of the inductor L02 is electrically connected to one end of the capacitor C00 that is not connected to the inductor L01, and the other end of the inductor L02 is electrically connected to one end of the inductor L01 that is not connected to the capacitor C00.

As illustrated in FIG. 17, the frequency-selective filter circuit of the first matching circuit M1 includes the capacitor C01, the capacitor C02, the inductor L01, and the inductor L02. The capacitor C01 is connected in parallel with the inductor L01. The capacitor C02 is connected in parallel with the inductor L02. One end of a whole formed by connecting the capacitor C02 and the inductor L02 in parallel is electrically connected to one end of a whole formed by connecting the capacitor C01 and the inductor L01 in parallel.

As illustrated in FIG. 18, the frequency-selective filter circuit of the first matching circuit M1 includes the capacitor C01, the capacitor C02, the inductor L01, and the inductor L02. The capacitor C01 is connected in series with the inductor L01 to form a first unit 101. The capacitor C02 is connected in series with the inductor L02 to form a second unit 102. The first unit 101 is connected in parallel with the second unit 102.

The antenna principle of the third feed system 40 during operation is exemplified below in conjunction with the accompanying drawings.

As illustrated in FIG. 19, the first radiator 11 further includes a first connection point B2. The first connection point B2 is located at the first feed point A1, or the first connection point B2 is located between the first feed point A1 and the second feed point A2.

As illustrated in FIG. 19, the antenna module 100 further includes a first band-pass circuit 23. One end of the first band-pass circuit 23 is electrically connected to the first connection point B2, and the other end of the first band-pass circuit 23 is electrically connected to the reference ground GND. The first band-pass circuit 23 is configured to conduct the third electromagnetic wave signal (MHB+UHB frequency band) to the reference ground GND. The first band-pass circuit 23 achieves a low impedance to ground for the MHB+UHB frequency band. In present disclosure, the low impedance for a certain frequency band means that the impedance is close to zero. In other words, it is equivalent to the effect of short circuit, that is, the frequency band is in a conduction state. The first band-pass circuit 23 has a low impedance to ground for the MHB+UHB frequency band, which means that the first band-pass circuit 23 conducts the signal of the MHB+UHB frequency band on the first radiator 11 to the reference ground GND, so that the signal of the MHB+UHB frequency band may no longer or less be transmitted to the ground through the first grounding end 111.

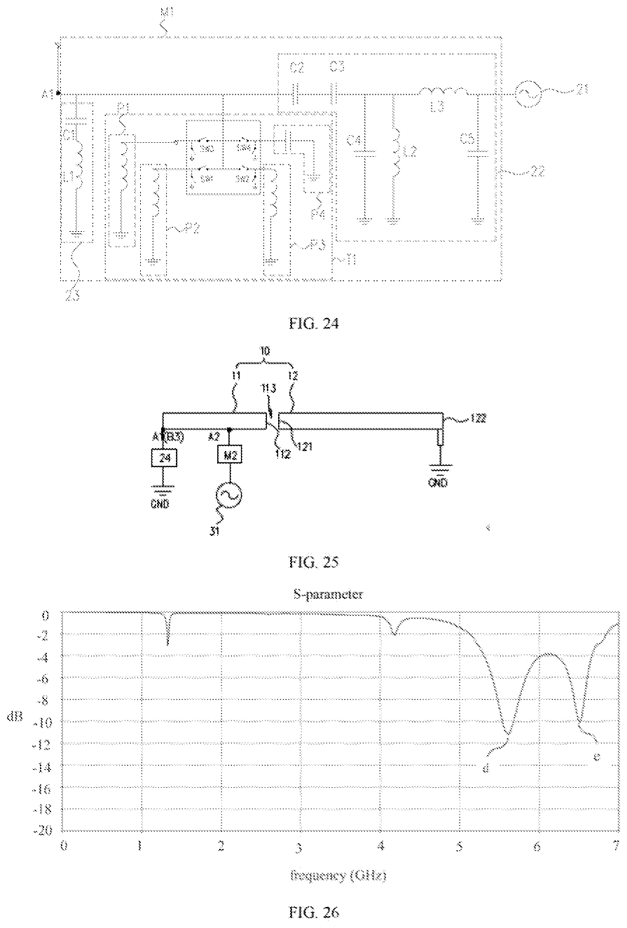

Further, the first band-pass circuit 23 is a part of the first matching circuit M1 (As also illustrated in FIG. 24). The first connection point B2 is the first feed point A1. One end of the first band-pass circuit 23 is electrically connected to the first feed point A1, and the other end of the first band-pass circuit 23 is electrically connected to the reference ground GND. The first band-pass circuit 23 conducts the third electromagnetic wave signal (MHB+UHB frequency band) to the reference ground GND, to form an equivalent antenna form view as shown in FIG. 20. In some embodiments, the first band-pass circuit 23 and the first matching circuit M1 may also be electrically connected to the first feed point A1 in parallel.

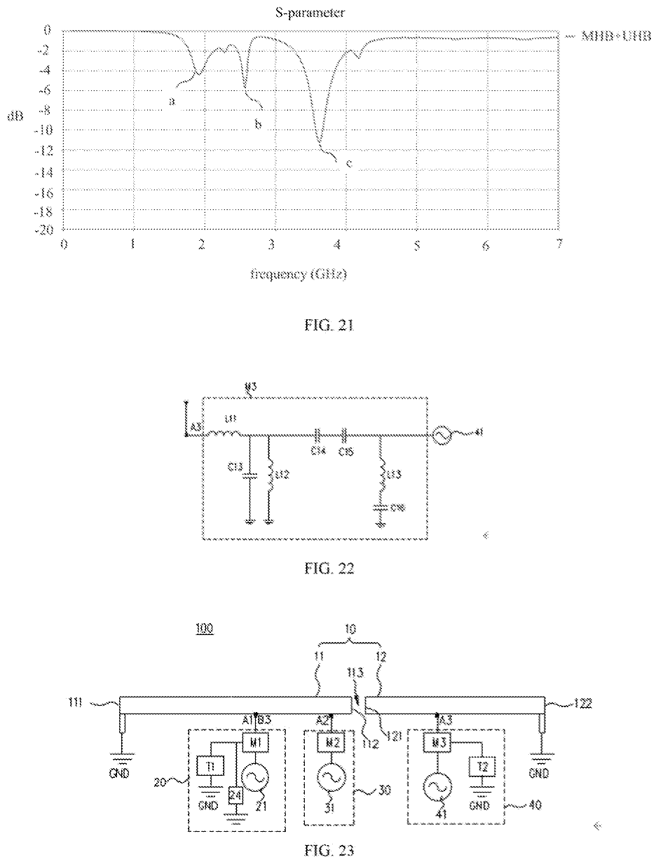

As illustrated in FIG. 20. FIG. 20 is an antenna schematic view of the third feed system 40 during operation. The third feed system 40 excites the first radiator 11 and the second radiator 12 to generate at least three resonance modes. The frequency band supported by the at least three resonance modes is in the MHB+UHB frequency band, such as shown in FIG. 21.

As illustrated in FIG. 21, the radiator 10 (including the first radiator 11 and the second radiator 12) supports a first resonance mode a, a second resonance mode b, and a third resonance mode c under the excitation of the third feed system 40.

A current of the first resonance mode a is at least distributed between the second coupling end 121 and the second grounding end 122. The third feed system 40 excites the radiator 10 to generate the first resonance mode a, and the current (referred to as a first resonant current in the present disclosure) corresponding to the first resonance mode a is mainly distributed between the second coupling end 121 of the second radiator 12 and the second grounding end 122. A direction of the resonant current is not specifically limited in the present disclosure. The terms “the first resonant current is mainly distributed between the second coupling end 121 of the second radiator 12 and the second grounding end 122” mean that the stronger current is distributed between the second coupling end 121 of the second radiator 12 and the second grounding end 122. It is not excluded that a small amount of first resonant current is distributed on the first radiator 11 due to the coupling effect of the first radiator 11 and the second radiator 12.

The first resonance mode a includes a ¼ wavelength mode of the second radiator 12. The first resonance mode a includes the ¼ wavelength mode where the first resonant current mainly operates from the second coupling end 121 of the second radiator 12 to the second grounding end 122. The ¼ wavelength mode may be understood to mean that an effective electrical length from the second coupling end 121 of the second radiator 12 to the second grounding end 122 is approximately ¼ times the medium wavelength (wavelength in the medium) corresponding to the center frequency of the resonance mode. This description is used for understanding terminology, but not limit the length of the second radiator 12. In some embodiments, the resonance mode generated by the third feed system 40 exciting the radiator 10 may also be a higher-order mode where the first resonant current mainly operates on the second radiator 12, such as the ½ wavelength mode, the ¾ wavelength mode, etc.

A current of the second resonance mode b is at least distributed between the first connection point B2 and the first coupling end 112 and between the second coupling end 121 and the third feed point A3. The current corresponding to the second resonance mode b generated by the third feed system 40 exciting the radiator 10 (referred to as a second resonant current in the present disclosure) is mainly distributed between the first connection point B2 and the first coupling end 112 and between the second coupling end 121 and the third feed point A3. The direction of the resonant current is not specifically limited in the present disclosure. The terms “second resonant current is mainly distributed between the first connection point B2 and the first coupling end 112 and between the second coupling end 121 and the third feed point A3” mean that the strong current is distributed between the first connection point B2 and the first coupling end 112 and between the second coupling end 121 and the third feed point A3. It is not excluded that a small amount of the second resonant current is distributed on other parts of the first radiator 11 and other parts of the second radiator 12.

The second resonance mode b includes a ¼ wavelength mode between the first connection point B2 of the first radiator 11 and the first coupling end 112. The second resonance mode b includes a ¼ wavelength mode where the second resonant current mainly operates from the first connection point B2 of the first radiator 11 to the first coupling end 112. The ¼ wavelength mode may be understood to mean that an effective electrical length from the first connection point B2 of the first radiator 11 to the first coupling end 112 is approximately ¼ times the medium wavelength (wavelength in the medium) corresponding to the center frequency of the resonance mode. This description is used for understanding terminology, but not limit the length from the first connection point B2 of the first radiator 11 to the first coupling end 112. In some embodiments, the resonance mode generated by the third feed system 40 exciting the radiator 10 may also be a higher-order mode where the second resonant current mainly operates on the radiator 10, such as the ½ wavelength mode, the ¾ wavelength mode, etc.

A current in the third resonance mode c is at least distributed between the second coupling end 121 of the second radiator 12 and the third feed point A3. The current corresponding to the third resonance mode c generated by the third feed system 40 exciting the radiator 10 (referred to as the third resonant current in the present disclosure) is mainly distributed between the second coupling end 121 of the second radiator 12 to the third feed point A3. The direction of the resonant current is not specifically limited in the present disclosure. The terms “third resonant current is mainly distributed between the second coupling end 121 of the second radiator 12 and the third feed point A3” mean that the stronger current is distributed between the second coupling end 121 of the second radiator 12 and the third feed point A3. It is not excluded that a small amount of third resonant current is distributed at other positions of the first radiator 11 and other positions of the second radiator 12 due to the coupling effect of the first radiator 11 and the second radiator 12.

The third resonance mode c includes a ¼ wavelength mode between the second coupling end 121 of the second radiator 12 and the third feed point A3. The third resonance mode c includes a ¼ wavelength mode where the third resonant current mainly operates from the second coupling end 121 of the second radiator 12 to the third feed point A3. The ¼ wavelength mode may be understood to mean that an effective electrical length from the second coupling end 121 of the second radiator 12 to the third feed point A3 is approximately ¼ times the medium wavelength (wavelength in the medium) corresponding to the center frequency of the resonance mode. This description is used for understanding terminology, but not limit the length from the second coupling end 121 of the second radiator 12 to the third feed point A3. In some embodiments, the resonance mode generated by the third feed system 40 exciting the radiator 10 may also be a higher-order mode where the third resonant current mainly operates on the radiator 10, such as the ½ wavelength mode, the ¾ wavelength mode, etc.

The first band-pass circuit 23 is electrically connected to the first feed point A1 or electrically connected between the first feed point A1 and the second feed point A2, and the first band-pass circuit 23 is configured to conduct the third electromagnetic wave signal (MHB+UHB frequency band) to the reference ground GND. Thus, the third electromagnetic wave signal (MHB+UHB frequency band) returns to the ground through the first band-pass circuit 23 at the first feed point A1, without affecting the transceiving of the first electromagnetic wave signal by the first feed system 20. By means of the current path planning for the third electromagnetic wave signal (MHB+UHB frequency band), the third feed system 40 excites the first radiator 11 and the second radiator 12 to generate the first resonance mode a, the second resonance mode b, and the third resonance mode c. The third feed system 40 multiplexes the first radiator 11 and the second radiator 12 coupled with each other to generate the three resonance modes. For example, seen from the second resonance mode b, the second resonant current forms current distribution (or current density distribution) on the first radiator 11 and the second radiator 12, and the three resonance modes are all within the MHB+UHB frequency band. Thus, the third electromagnetic wave signal forms a relatively wide bandwidth in the MHB+UHB frequency band, to improve the coverage rate of the antenna module 100 for the MHB+UHB frequency band.

The order of the wavelength modes of the first resonance mode a, the second resonance mode b and the third resonance mode c may be determined according to the length of the radiator 10 which the resonant current mainly operates. Seen from the wavelength modes of the first resonance mode a, the second resonance mode b, and the third resonance mode c, the first resonance mode a, the second resonance mode b, and the third resonance mode c are all ¼ wavelength mode. The ¼ wavelength mode is also called basic mode, and the basic mode is a high-efficiency mode, thereby achieving high-efficiency and wide coverage in MHB+UHB frequency band.

The third matching circuit M3 is configured to tune a center frequency and a bandwidth of the third electromagnetic wave signal (MHB+UHB frequency band). A structure of the third matching circuit M3 provided by the present disclosure is exemplified below in conjunction with the accompanying drawings.

As illustrated in FIG. 22, the third matching circuit M3 includes an eleventh inductor L11, a twelfth inductor L12, a thirteenth inductor L13, a thirteenth capacitor C13, a fourteenth capacitor C14, a fifteenth capacitor C15, and a sixteenth capacitor C16. One end of the eleventh inductor L11 is electrically connected to the third feed point A3. The other end of the eleventh inductor L11 is electrically connected to one end of the twelfth inductor L12, one end of the thirteenth capacitor C13, and one end of the fourteenth capacitor C14. The other end of the twelfth inductor L12 and the other end of the thirteenth capacitor C13 are electrically connected to the reference ground. The other end of the fourteenth capacitor C14 is electrically connected to one end of the fifteenth capacitor C15, and the other end of the fifteenth capacitor C15 is electrically connected to one end of the thirteenth inductor L13 and one end of the third signal source 41. The other end of the thirteenth inductor L13 is electrically connected to one end of the sixteenth capacitor C16, and the other end of the sixteenth capacitor C16 is electrically connected to the reference ground. The third matching circuit M3 is disposed, so as to tune the center frequency and the bandwidth of the third electromagnetic wave signal (MHB+UHB frequency band), so that the resonance frequencies and bandwidths of the first resonance mode a, the second resonance mode b, and the third resonance mode c may be tuned to promote the wide coverage of the antenna module 100 in the MHB+UHB frequency band.

Further, as illustrated in FIG. 20, the antenna module 100 further includes a second adjusting circuit T2, and one end of the second adjusting circuit T2 is electrically connected to the reference ground GND. The other end of the second adjusting circuit T2 is electrically connected to the second radiator 12 or electrically connected to the third matching circuit M3. The second adjusting circuit T2 is configured to adjust the frequency band of the third electromagnetic wave signal (MHB+UHB frequency band). The second adjusting circuit T2 has similar functions as the first adjusting circuit T1. The structure of the second adjusting circuit T2 is also similar to that of the first adjusting circuit T1, including at least one of the variable capacitor and a plurality of switch selection circuits, and the switch selection circuit may refer to the description of the first adjusting circuit T1, which may not be repeated here.

The adjusting principle of the second adjusting circuit T2 for the third electromagnetic wave signal (MHB+UHB frequency band) is the same as that of the first adjusting circuit T1 for the first electromagnetic wave signal. By disposing the second adjusting circuit T2, the second adjusting circuit T2 switches the third electromagnetic wave signal (MHB+UHB frequency band) in a different frequency band, so as to raise coverage rate in MHB+UHB frequency band. Thus, the antenna module 100 may support several application frequency bands of MHB+UHB frequency band, and further may support use frequency bands of different places. The antenna module 100 and the electronic device 1000 including the antenna module 100 may be used in the world and may support the mobile communication signals of different operators.

An antenna principle of the second feed system 30 during operation is exemplified below in conjunction with the accompanying drawings.

As illustrated in FIG. 23, the first radiator 11 further includes a second connection point B3. The second connection point B3 is located on the first feed point A1, or the second connection point B3 is located between the first feed point A1 and the second feed point A2. According to the working principle of the third feed system 40, the second connection point B3 and the first connection point B2 may be the same point or two different points.

As illustrated in FIG. 23, the antenna module 100 further includes a second band-pass circuit 24. One end of the second band-pass circuit 24 is electrically connected to the second connection point B3, and the other end of the second band-pass circuit 24 is electrically connected to the reference ground GND. The second band-pass circuit 24 is configured to conduct the second electromagnetic wave signal (such as Wi-Fi 5G and/or Wi-Fi 6E signal) to the reference ground GND, so as to achieve a low impedance to ground for the second electromagnetic wave signal (such as Wi-Fi 5G and/or Wi-Fi 6E signal). The terms “the second band-pass circuit 24 has a low impedance to ground for the Wi-Fi 5G and/or Wi-Fi 6E frequency band” mean that the second band-pass circuit 24 conducts the signals in the Wi-Fi 5G and/or Wi-Fi 6E frequency band on the first radiator 11 to the reference GND, so that the signals in the Wi-Fi 5G and/or Wi-Fi 6E frequency band may no longer or less be transmitted to ground through the first ground terminal 111.

In some embodiments, the first band-pass circuit 23 and the second band-pass circuit 24 may be the same circuit or two independent circuits. Even if the first connection point B2 and the second connection point B3 are the same point, the first band-pass circuit 23 and the second band-pass circuit 24 may also be two independent circuits.

As illustrated in FIG. 24, at least one of the first band-pass circuit 23 and the second band-pass circuit 24 includes a first capacitor C1 and a first inductor L1. One end of the first capacitor C1 is electrically connected to the first feed point A1, and the other end of the first capacitor C1 is electrically connected to one end of the first inductor L1, and the other end of the first inductor L1 is electrically connected to the reference ground GND. In some embodiments, the first band-pass circuit 23 and/or the second band-pass circuit 24 may also be a combination of three resonant elements, such as the structures of FIG. 13 to FIG. 16. The first band-pass circuit 23 and/or the second band-pass circuit 24 may also be a combination of four resonant elements, a combination of five resonant elements, or a combination of more resonant elements. The resonant elements are the capacitors or the inductors.

In the present embodiment, the first connection point B2 and the second connection point B3 are the same point, and the first band-pass circuit 23 and the second band-pass circuit 24 are the same circuit. The circuit simultaneously has a low impedance to the ground reference GND for the Wi-Fi 5G+Wi-Fi 6E frequency band+MHB+UHB frequency band. For example, the first band-pass circuit 23 and the second band-pass circuit 24 are the same circuit, and the circuit includes the first capacitor C1 and the first inductor L1. One end of the first capacitor C1 is electrically connected to the first feed point A1, the other end of the first capacitor C1 is electrically connected to one end of the first inductor L1, and the other end of the first inductor L1 is electrically connected to the reference ground GND. In the following embodiments of the present disclosure, the first band-pass circuit 23 and the second band-pass circuit 24 as the same circuit is exemplified, which may not be described in detail later.

In some embodiments, the first band-pass circuit 23 and the second band-pass circuit 24 are two different circuits, and the first connection point B2 and the second connection point B3 are different points or the same points.

At least one of the first band-pass circuit 23 and the second band-pass circuit 24 being a part of the first matching circuit M1 specifically includes the following situations. A first situation is that the first band-pass circuit 23 is a part of the first matching circuit M1, and the second band-pass circuit 24 and the first matching circuit M1 are connected in parallel with the first radiator 11. A second situation is that the second band-pass circuit 24 is a part of the first matching circuit M1, and the first band-pass circuit 23 and the first matching circuit M1 are connected in parallel to the first radiator 11. A third situation is that the first band-pass circuit 23 and the second band-pass circuit 24 are different circuits and are part of the first matching circuit M1. A fourth situation is that the first band-pass circuit 23 and the second band-pass circuit 24 are the same circuit and are a part of the first matching circuit M1.

In the present embodiment, the second band-pass circuit 24 is a part of the first matching circuit M1, and the second connection point B3 is the first feed point A1. One end of the second band-pass circuit 24 is electrically connected to the first feed point A1, and the other end of the second band-pass circuit 24 is electrically connected to the reference ground GND. The second band-pass circuit 24 conducts the second electromagnetic wave signal to the reference ground GND, so as to form an equivalent antenna form view as shown in FIG. 25.

As illustrated in FIG. 25, FIG. 25 is an antenna schematic view of the second feed system 30 during operation. The second feed system 30 excites the first radiator 11 and the second radiator 12 to generate at least two resonance modes. The frequency band that is supported by the at least two resonance modes supports the second electromagnetic wave signal. In this embodiment, the second electromagnetic wave signal as the Wi-Fi 5G and/or Wi-Fi 6E frequency band is taken as an example for explaining. For example, as shown in FIG. 26, the second feed system 30 excites the first radiator 11 and the second radiator 12 to generate at least two resonance modes covering the Wi-Fi 5G frequency band (such as 5150-5850 MHz). Alternatively, the second feed system 30 excites the first radiator 11 and the second radiator 12 to generate at least two resonance modes covering the Wi-Fi 6E frequency band (such as 5.925 GHz-7.125 GHz). Alternatively, the second feed system 30 excites the first radiator 11 and the second radiator 12 to generate at least two resonance modes covering the Wi-Fi 5G frequency band and the Wi-Fi 6E frequency band (such as 5150-5850 MHz, and 5.925 GHz-7.125 GHz).

As illustrated in FIG. 26, the radiator 10 (including the first radiator 11 and the second radiator 12) supports the fourth resonance mode d and the fifth resonance mode e under the excitation of the second feed system 30.

A current of the fourth resonance mode d is at least distributed between the second feed point A2 of the first radiator 11 and the first coupling end 112. The current (referred to as the fourth resonant current in the present disclosure) corresponding to the fourth resonance mode d generated by the second feed system 30 exciting the radiator 10 is mainly distributed between the second feed point A2 of the first radiator 11 and the first coupling end 112. The direction of the resonant current is specifically limited in the present disclosure. The terms “the fourth resonant current is mainly distributed between the second feed point A2 of the first radiator 11 and the first coupling end 112” mean that the stronger current is distributed between the second feed point A2 of the first radiator 11 and the first coupling end 112. It is not excluded that a small amount of fourth resonant current is distributed at other positions of the first radiator 11 or on other positions of the second radiator 12 due to the coupling effect of the first radiator 11 and the second radiator 12.

The fourth resonance mode d includes a ¼ wavelength mode between the second feed point A2 of the first radiator 11 and the first coupling end 112. The fourth resonance mode d includes a ¼ wavelength mode where the fourth resonant current mainly operates from the second feed point A2 of the first radiator 11 and the first coupling end 112. The ¼ wavelength mode is understood to mean that an effective electrical length from the second feed point A2 of the first radiator 11 to the first coupling end 112 is approximately ¼ times the medium wavelength (wavelength in the medium) corresponding to the center frequency of the resonance mode. This description is used for understanding terminology, but not limit the length from the second feed point A2 of the first radiator 11 to the first coupling end 112. In some embodiments, the resonance mode generated by the second feed system 30 exciting the radiator 10 may also be a higher-order mode where the fourth resonant current mainly operates on the first radiator 11 and the second radiator 12, such as the ½ wavelength mode, the ¾ wavelength mode, etc.

A current of the fifth resonance mode e is distributed at least between the second feed point A2 and the second grounding end 122. The current (referred to as a fifth resonant current in present disclosure) corresponding to the fifth resonance mode e generated by the second feed system 30 exciting the radiator 10 is mainly distributed between the second coupling end 121 of the second radiator 12 and the second grounding end 122. The direction of the resonant current is specifically limited in the present disclosure. The terms “the fifth resonant current is mainly distributed between the second coupling end 121 of the second radiator 12 and the second grounding end 122” mean that the stronger current is distributed between the second coupling end 121 of the second radiator 12 and the second grounding end 122. It is not excluded that a small amount of the first resonant current is distributed on the first radiator 11 due to the coupling effect of the first radiator 11 and the second radiator 12.

The fifth resonance mode e includes a ¾ wavelength mode of the second radiator 12. The fifth resonance mode e includes a ¾ wavelength mode where the fifth resonant current mainly operates from the second coupling end 121 to the second grounding end 122 of the second radiator 12. The ¾ wavelength mode may be understood to mean that an effective electrical length from the second coupling end 121 of the second radiator 12 to the second grounding end 122 is approximately ¾ times the medium wavelength (wavelength in the medium) corresponding to the center frequency of the resonance mode. This description is used for understanding terminology, but not limit the length of the second radiator 12. In some embodiments, the resonance mode generated by the second feed system 30 exciting the radiator 10 may also be other higher-order modes where the fifth resonant current mainly operates on the second radiator 12, such as the ½ wavelength mode, etc.

The second band-pass circuit 24 is electrically connected to the first feed point A1, and the second band-pass circuit 24 is configured to conduct the second electromagnetic wave signal (Wi-Fi 5G frequency band, Wi-Fi 6E frequency band) to the reference ground GND. Thus, the second electromagnetic wave signal (Wi-Fi 5G frequency band, Wi-Fi 6E frequency band) returns to the ground through the second band-pass circuit 24 at the first feed point A1, without affecting the transceiving of the first electromagnetic wave signal by the first feed system 20. The first matching circuit M1 may achieve the current path planning for the second electromagnetic wave signal (Wi-Fi 5G frequency band, Wi-Fi 6E frequency band), so that the second feed system 30 excites the first radiator 11 and the second radiator 12 to generate the fourth resonance mode d and the fifth resonance mode e. The second feed system 30 multiplexes the first radiator 11 and the second radiator 12 coupled with each other to generate the two resonance modes. For example, seen from the fifth resonance mode e, the fifth resonant current forms the current distribution (or the current density distribution) on the first radiator 11 and the second radiator 12, and the two resonance modes cover the Wi-Fi 5G frequency band and/or the Wi-Fi 6E frequency band. Thus, the antenna module 100 forms a relatively wide bandwidth in the Wi-Fi 5G frequency band and/or the Wi-Fi 6E frequency band, to improve the coverage rate of the antenna module 100 on the Wi-Fi 5G frequency band and/or the Wi-Fi 6E frequency band.

The order of the wavelength modes of the fourth resonance mode d and the fifth resonance mode e may be changed according to the frequency of each wavelength mode. Seen from the wavelength modes of the fourth resonance mode d and the fifth resonance mode e, the fourth resonance mode d and the fifth resonance mode e operate in the high-efficiency mode, thereby achieving high-efficiency and wide coverage in the Wi-Fi 5G frequency band and/or Wi-Fi 6E frequency band.

Further, the first band-pass circuit 23 and the second band-pass circuit 24 are the same circuit, and is a part of the first matching circuit M1, so that the first matching circuit M1 may achieve the current path planning for the second electromagnetic wave signal (Wi-Fi 5G frequency band, Wi-Fi 6E frequency band) and the third electromagnetic wave signal. Thus, the third feed system 40 excites the first radiator 11 and the second radiator 12 to generate the first resonance mode a, the second resonance mode b, and the third resonance mode c. The second feed system 30 excites the first radiator 11 and the second radiator 12 to generate the fourth resonance mode d and the fifth resonance mode e. Thus, the high efficiency and the wide coverage for the MHB+UHB frequency band, the Wi-Fi 5G frequency band and/or the Wi-Fi 6E frequency band may be achieved. In addition, the band-pass circuit also transmits the second electromagnetic wave signal (Wi-Fi 5G frequency band, Wi-Fi 6E frequency band) and the third electromagnetic wave signal (MHB+UHB frequency band) to the reference ground GND, so that the second electromagnetic wave signal (Wi-Fi 5G frequency band, Wi-Fi 6E frequency band) and the third electromagnetic wave signal (MHB+UHB frequency band) have no influence on the transceiving of the first electromagnetic wave signal (LB frequency band).

A specific configuration of the second matching circuit M2 may be exemplified below in conjunction with specific embodiments.

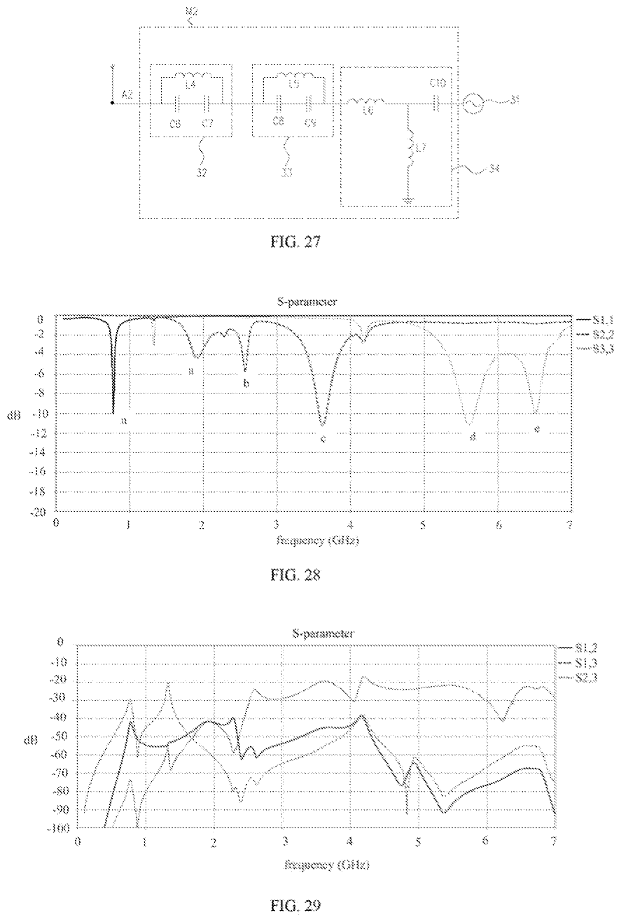

As illustrated in FIG. 27, the second matching circuit M2 includes a first band-stop circuit 32, a second band-stop circuit 33, and a second tuning circuit 34 that are sequentially connected between the second feed point A2 and the second signal source 31. The first band-stop circuit 32 is configured to filter the first electromagnetic wave signal. That is, the first band-stop circuit 32 is a band-stop circuit of LB, to filter the electromagnetic wave signal of the LB frequency band. The second band-stop circuit 33 is configured to filter the third electromagnetic wave signal. That is, the second band-stop circuit 33 is the band-stop circuit in the MHB+UHB frequency band, to filter the electromagnetic wave signals in the MHB+UHB frequency bands. The first band-stop circuit 32 is configured for not affecting the first radiator 11 to generate the above resonance modes under the excitation of the first feed system 20, so as to form a current profile as described above, thereby supporting the transceiving of the LB frequency band. The second band-stop circuit 33 is configured for not affecting the first resonance mode a, the second resonance mode b, and the third resonance mode c generated by the third electromagnetic wave signal, so as to allow the radiator 10 to form the current distribution corresponding to the first resonance mode a, the second resonance mode b, and the third resonance mode c, thereby supporting the transceiving of the MHB+UHB frequency band.

For example, as illustrated in FIG. 27, the first band-stop circuit 32 includes a sixth capacitor C6, a seventh capacitor C7, and a fourth inductor L4. One end of the sixth capacitor C6 and one end of the fourth inductor L4 are electrically connected to the second feed point A2. The other end of the sixth capacitor C6 is electrically connected to one end of the seventh capacitor C7. The other end of the fourth inductor L4 is electrically connected to the other end of the seventh capacitor C7 and one end of the second band-stop circuit 33. The first band-stop circuit 32 realizes filtering of the first electromagnetic wave signal. In some embodiments, the first band-stop circuit 32 may also be composed of two resonant elements, three resonant elements, four resonant elements, five resonant elements, etc., wherein the resonant elements are the inductors or the capacitors.

For example, as illustrated in FIG. 27, the second band-stop circuit 33 includes an eighth capacitor C8, a ninth capacitor C9, and a fifth inductor L5. One end of the eighth capacitor C8 and one end of the fifth inductor L5 are electrically connected to the first band-stop circuit 32. In some embodiments, one end of the eighth capacitor C8 and one end of the fifth inductor L5 are electrically connected to the other end of the fourth inductor L4, and the other end of the eighth capacitor C8 is electrically connected to one end of the ninth capacitor C9. The other end of the fifth inductor L5 is electrically connected to the other end of the ninth capacitor C9 and one end of the second tuning circuit 34. The above-mentioned second band-stop circuit 33 realizes filtering of the second electromagnetic wave signal (Wi-Fi 5G frequency band, Wi-Fi 6E frequency band). In some embodiments, the first band-stop circuit 32 may also be composed of two resonant elements, three resonant elements, four resonant elements, five resonant elements, etc., wherein the resonant elements are inductors or capacitors.

The above description is a specific example of the first band-stop circuit 32 and a specific example of the second band-stop circuit 33. The specific example of the first band-stop circuit 32 may be matched with the second band-stop circuit 33 with other structure, and the specific example of the second band-stop circuit 33 may also be matched with the first band-stop circuit 32 with other structure.

The second tuning circuit 34 is configured to tune the resonance frequency and the bandwidth of the second electromagnetic wave signal (Wi-Fi 5G frequency band, Wi-Fi 6E frequency band).

For example, As illustrated in FIG. 27, the second tuning circuit 34 includes a sixth inductor L6, a seventh inductor L7, and a tenth capacitor C10. One end of the sixth inductor L6 is electrically connected to the other end of the second band-stop circuit 33, and the other end of the sixth inductor L6 is electrically connected to one end of the seventh inductor L7 and one end of the tenth capacitor C10. The other end of the seventh inductor L7 is electrically connected to the reference ground GND, and the other end of the tenth capacitor C10 is electrically connected to the second signal source 31.

The first band-stop circuit 32 and the second band-stop circuit 33 are disposed in the second matching circuit M2, to prevent the current of the first feed system 20 and the current of the third feed system 40 from passing through the second matching circuit M2 to ground. Instead, the current of the first feed system 20 is grounded through the first grounding end 111. The first band-pass circuit 23 and the second band-pass circuit 24 are disposed in the first matching circuit M1, so that the current of the third feed system 40 passes through the first band-pass circuit 23 at the first feed point A1 to ground, and the current of the second feed system 30 passes through the second band-pass circuit 24 at the first feed point A1 to ground. Thus, the resonance mode covering the LB band is generated. The first resonance mode a, the second resonance mode b, and the third resonance mode c covering the MHB+UHB frequency band are generated. The fourth resonance mode d and the fifth resonance mode e covering the Wi-Fi 5G and/or Wi-Fi 6E frequency bands are generated. The joint tuning of the first matching circuit M1, the second matching circuit M2, the third matching circuit M3, the first adjusting circuit T1, and the second adjusting circuit T2 may realize multi-frequency band wide coverage to the LB frequency band+MHB frequency band+UHB frequency band+Wi-Fi 5G frequency band+Wi-Fi 6E frequency band. The CA/ENDC of the LB+MHB+UHB may be ensured, and the resident state of the Wi-Fi 5G and/or the Wi-Fi 6E frequency bands may be maintained. The LB+MHB+UHB frequency band described in the present disclosure is a combined frequency band formed by the LB frequency band, the MHB frequency band, and the UHB frequency band, which is greater than 0 MHz and less than or equal to 6000 MHz.

As illustrated in FIG. 28, FIG. 28 is a graph illustrating S-parameters of the antenna module 100 in one state. S1,1 is an S-parameter curve covering the LB frequency band (i.e., the first electromagnetic wave signal), S2,2 is an S-parameter curve covering the MHB+UHB frequency band (i.e., the third electromagnetic wave signal), and S3,3 is an S-parameter curve covering the Wi-Fi 5G and/or Wi-Fi 6E frequency band (i.e., the second electromagnetic wave signal). According to S1,1, S2,2 and S3,3, it may be seen that the antenna module 100 provided by the present disclosure has a good coverage breadth in the LB frequency band+MHB frequency band+UHB frequency band+Wi-Fi 5G frequency band+Wi-Fi 6E frequency band.

As illustrated in FIG. 29, FIG. 29 is a graph illustrating S-parameters of the antenna module 100 in one state. Each of S1,2, S1,3 and S2,3 is an isolation degree curve between every two different signal sources. According to FIG. 29, it may be seen that the S parameters between two adjacent signal sources are all below-15 dB, which shows that every two adjacent signal sources have good isolation degree.

In the antenna module 100 provided by the present disclosure, the first feed system 20, the second feed system 30, and the third feed system 40 are disposed on the first radiator 11 and the second radiator 12 that are coupled to each other. An excitation current of the first feed system 20 forms a high-efficiency fundamental mode on the first radiator 11 to receive and transmit the first electromagnetic wave signal. The first matching circuit M1 is designed, the first band-pass circuit 23 for conducting the third electromagnetic wave signal (MHB+UHB band) is disposed, and the second band-pass circuit 24 for conducting the second electromagnetic wave signal (Wi-Fi 5G frequency band, Wi-Fi 6E frequency band) is disposed. The first band-pass circuit 23 and the second band-pass circuit 24 may be the same circuit. Thus, the excitation current of the second feed system 30 and the excitation current of the third feed system 40 are all grounded through the first feed point A1, so as to form specific current paths and excite the first radiator 11 and the second radiator 12 to generate the first resonance mode a, the second resonance mode b, the third resonance mode c supporting the third electromagnetic wave signal (MHB+UHB frequency band). At the same time, the first radiator 11 and the second radiator 12 are also excited to generate the fourth resonance mode d and the fifth resonance mode e supporting the second electromagnetic wave signal (Wi-Fi 5G frequency band, Wi-Fi 6E frequency band). The first adjusting circuit T1 and the second adjusting circuit T2 are disposed on the first matching circuit M1 and the third matching circuit M3 respectively, so as to achieve multi-band wide coverage in the LB frequency band+MHB frequency band+UHB frequency band+Wi-Fi 5G frequency band+Wi-Fi 6E frequency band. The common caliber technology is adopted, the antenna space utilization rate is improved, the internal space of the mobile phone is effectively saved, thereby facilitating better stacking of the whole machine. The multi-mode simultaneous operation is realized through a plurality of radiators 10, so that the bandwidth of the antenna is broadened, and high isolation degree of each frequency band is realized through applying different matching circuit forms.

The above description is the antenna module 100 provided by the first embodiment of the present disclosure. The antenna module 100 includes the first radiator 11 and the second radiator 12 coupled to each other, and three feed systems electrically connected to the first radiator 11 and the second radiator 12.

In general antenna technology, the development and utilization of the UHB frequency band for the mobile communication signal are relatively limited, such as generating a mode ranging from 3000 MHz to 5000 MHz. It is difficult to cover some UHB frequency bands. For example, it is difficult to cover a frequency band having a N78 broadband requirement (3300-4100 MHz).

The antenna module 100 provided by the second embodiment of the present disclosure is exemplified below in conjunction with the accompanying drawings.

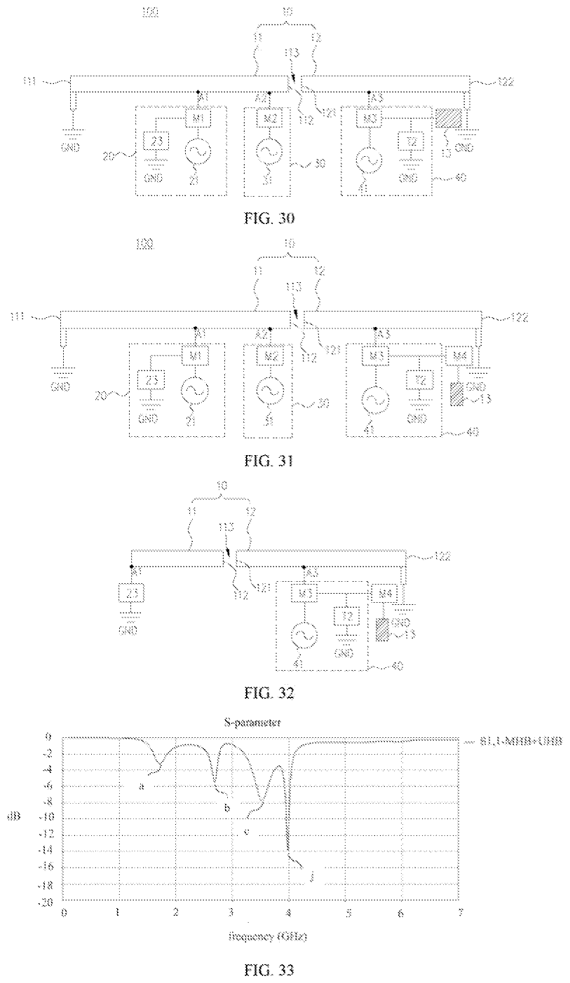

As illustrated in FIG. 30, the antenna module 100 provided by the present embodiment is based on the antenna module 100 provided by the first embodiment. The antenna module 100 of the present embodiment further includes a third radiator 13. The third radiator 13 is electrically connected to the third matching circuit M3, and the third radiator 13 is configured to receive and transmit a fourth electromagnetic wave signal under the excitation of the third feed system 40. The fourth electromagnetic wave signal is in the UHB frequency band range, for example, the fourth electromagnetic wave signal includes the N78 frequency band. An effective electrical length of the third radiator 13 corresponds to the UHB band, so that the third radiator 13 may generate at least one mode in the UHB frequency band. The third feed system 40 excites the first radiator 11 and the second radiator 12 to generate a mode in the UHB frequency band. Thus, the antenna module 100 generates at least two modes in the UHB frequency band. The at least two modes are spaced apart from each other, to form a wide coverage in the UHB band, so that the coverage of the antenna module 100 in the UHB frequency band is improved. In the whole antenna module 100, the third radiator 13 is disposed, and the third radiator 13 and the second radiator 12 are fed together. Thus, no new signal source needs to be added, and the coverage for the MHB frequency band+the UHB frequency band may be further provided. According to the design idea, the full frequency band coverage for the MHB frequency band+the UHB frequency band may be achieved.

For an antenna form of the third radiator 13, the antenna form of the third radiator 13 may be the same as or different from the antenna forms of the first radiator 11 and the second radiator 12. For example, the first radiator 11 and the second radiator 12 are metal frame antennas. The third radiator 13 may be disposed in the housing 300. On one hand, the third radiator 13 is close to the third signal source 41, so as to reduce feed paths and avoid mutual interference between the third radiator 13 and the installation positions of the second radiator 12. On the other hand, since the frequency band supported by the third radiator 13 is relatively high, the size of the third radiator 13 relatively reduces, so that a space occupied by the third radiator 13 disposed in the housing 300 is relatively small. The third radiator 13 is a flexible circuit board radiator, or a laser direct molding radiator, or a printing radiator. The third radiator 13 of the antenna module 100 is integrated on the flexible circuit board, or is directly formed in the housing 300 by laser, or is directly formed in the housing 300 by printing, so that the third radiator 13 is close to the third feed system 40. Thus, a thickness of the third radiator 13 is relatively small, and the third radiator 13 is light and thin. The third radiator 13 may be in a flexible and bendable form, so that the third radiator may be conveniently disposed in a narrow space or a curved surface space of the housing 300. The compactness of devices in the electronic device 1000 may be improved.

Further, as illustrated in FIG. 31, the antenna module 100 further includes a fourth matching circuit M4. One end of the fourth matching circuit M4 is electrically connected between the third matching circuit M3 and the third signal source 41, and the other end of the fourth matching circuit M4 is electrically connected to the third radiator 13. The fourth matching circuit M4 is configured to tune the resonant frequency and the bandwidth of the fourth electromagnetic wave signal.

As illustrated in FIG. 32, the second radiator 12 and the third radiator 13 obtain an equivalent antenna form of the third signal source 41 under excitation of the third feed system 40, as shown in FIG. 32.

As illustrated in FIG. 33, the third signal source 41 excites the third radiator 13 through the fourth matching circuit M4 and the third matching circuit M3 to generate a tenth resonance mode j (a sixth resonance mode to a ninth resonance mode may be described later). The tenth resonance mode j includes ¼ wavelength mode of the third radiator 13. The first resonance mode a, the second resonance mode b, the third resonance mode c, and the tenth resonance mode j form four resonance modes, to achieve the full frequency range coverage of the antenna module 100 in MHB frequency range and UHB frequency range.

In the present disclosure, a structure of the fourth matching circuit M4 is not specifically limited, and the structure of the fourth matching circuit M4 are exemplified in following embodiments. The specific structure of the fourth matching circuit M4 includes but is not limited to the structures in the following embodiments.

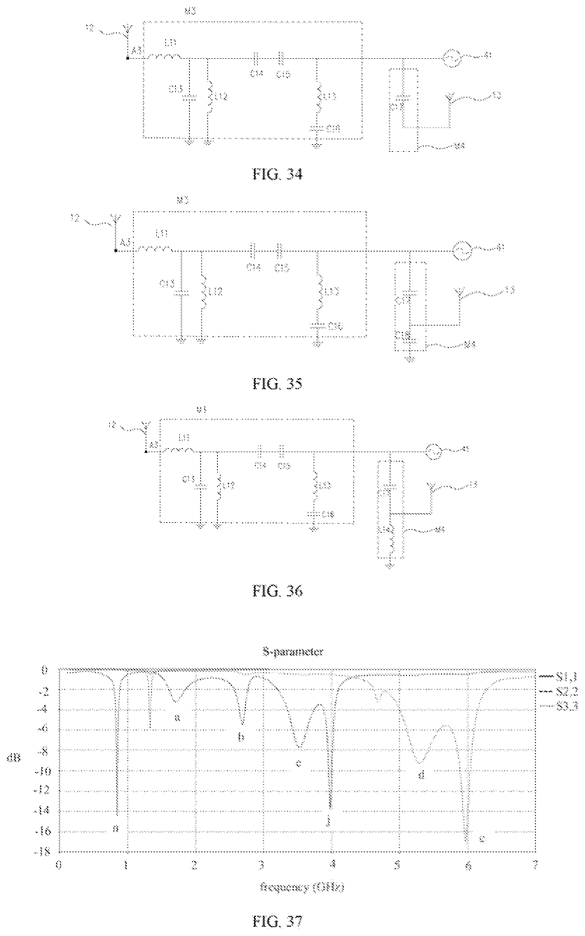

In some embodiments, as illustrated in FIG. 34, the fourth matching circuit M4 includes a seventeenth capacitor C17, one end of the seventeenth capacitor C17 is electrically connected to the third signal source 41, and the other end of the seventeenth capacitor C17 is electrically connected to the third radiator 13.

In some embodiments, as illustrated in FIG. 35, the fourth matching circuit M4 includes the seventeenth capacitor C17 and an eighteenth capacitor C18. One end of the seventeenth capacitor C17 is electrically connected to the third signal source 41, the other end of the seventeenth capacitor C17 is electrically connected to the third radiator 13 and one end of the eighteenth capacitor C18, and the other end of the eighteenth capacitor C18 is electrically connected to the reference ground GND.

In some embodiments, as illustrated in FIG. 36, the fourth matching circuit M4 includes the seventeenth capacitor C17 and a fourteenth inductor L14. One end of the seventeenth capacitor C17 is electrically connected to the third signal source 41, the other end of the seventeenth capacitor C17 is electrically connected to one end of the third radiator 13 and one end of the fourteenth inductor L14, and the other end of the fourteenth inductor L14 is electrically connected to the reference ground GND.

The fourth matching circuit M4 provided by the above embodiments may tune the resonant frequency and the bandwidth of the fourth electromagnetic wave signal. In some embodiments, other resonant elements may be added, and the resonant elements includes the capacitors or the inductors.

As illustrated in 37, FIG. 37 is graph illustrating the S-parameters of the antenna module 100 provided by the present disclosure in one state. S1,1 is an S-parameter curve covering the LB frequency band, S2,2 is an S-parameter curve covering the MHB+UHB frequency band, and S3,3 is an S-parameter curve covering the Wi-Fi 5G and/or Wi-Fi 6E frequency bands. According to S1,1, S2, 2 and S3, 3, it may be seen that the antenna module 100 provided by the present disclosure has a good coverage breadth in the LB frequency band+MHB frequency band+UHB frequency band+Wi-Fi 5G frequency band+Wi-Fi 6E frequency band.

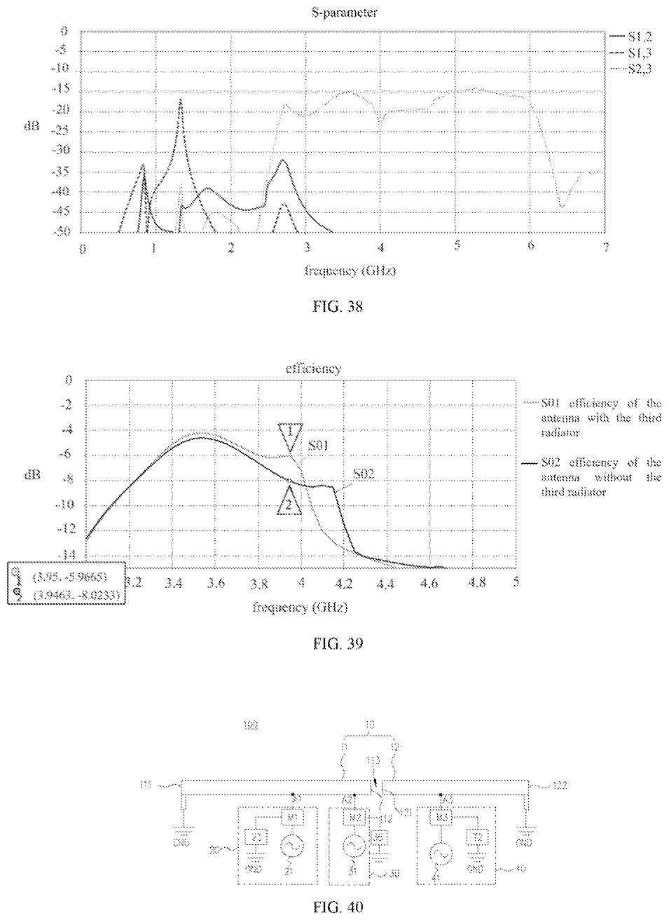

As illustrated in FIG. 38, FIG. 38 is a graph illustrating isolation degrees of the antenna module 100 provided by the present disclosure in one state. Each of S1,2, S1,3 and S2,3 is an isolation degree curve between every two different signal sources. According to FIG. 38, it may be seen that the S parameters between two adjacent signal sources are all below-15 dB, which shows that every two adjacent signal sources have good isolation degree.

As illustrated in FIG. 39, FIG. 39 is an efficiency view of the antenna module 100 provided by the embodiments of the present disclosure. A curve S01 and a curve S02 are the efficiency curves of the antenna module 100 with and without the third radiator 13, respectively. At the first point of the curve S01 and the second point of the curve S02, the efficiency is about 3.95 GHz. The efficiency of the antenna module 100 with the third radiator 13 at about 3.95 GHz is greater than that of the antenna module 100 without the third radiator 13 at about 3.95 GHz. Moreover, the efficiency of the antenna module 100 with the third radiator 13 in a range from 3300 MHz to 4100 MHz frequency band is greater than that of antenna module 100 without the third radiator 13 in the range from 3300 MHz to 4100 MHz frequency band. In other words, the bandwidth increases after disposing the third radiator 13, and the efficiency increases in the range from 3300 to 4100 MHz frequency band.

The present disclosure also provides other implementations for realizing full frequency band coverage of the MHB frequency band+the UHB frequency band, especially for improving the coverage of the UHB frequency band. The antenna module 100 provided by the third embodiment of the present disclosure is exemplified below in conjunction with the accompanying drawings.

As illustrated in FIG. 40, the antenna module 100 provided by the present embodiment is approximately the same as the antenna module 100 provided by the first embodiment. The main difference is that the second matching circuit M2 in the present embodiment further includes a third band-pass circuit 35. One end of the third band-pass circuit 35 is electrically connected to the second feed point A2 or between the first band-stop circuit 32 and the second band-stop circuit 33. The other end of the third band-pass circuit 35 is electrically connected to the reference ground GND.

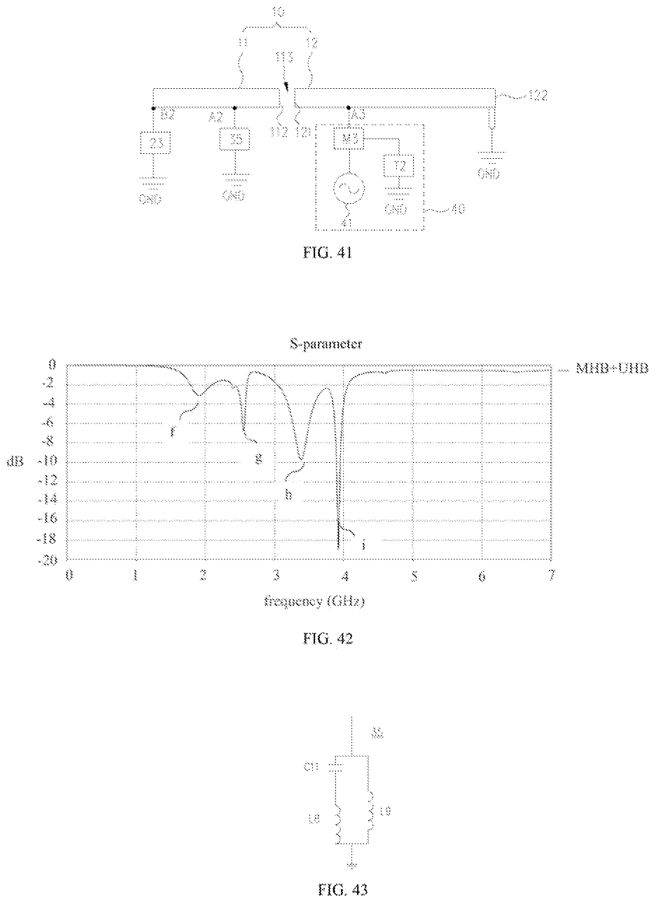

The third electromagnetic wave signal includes the mobile communication signal of the third frequency band. The third frequency band belongs to the UHB frequency band. For example, the third band-pass circuit 35 includes the N78 frequency band. The third band-pass circuit 35 is configured for conducting the mobile communication signal of the third frequency band to the reference ground GND. The third band-pass circuit 35 achieves the low impedance to ground for the mobile communication signal of the third frequency band, to obtain corresponding equivalent antenna form shown in FIG. 41. In response to the third frequency band is the N78 frequency band, the third band-pass circuit 35 realizes the low impedance to ground for the N78 frequency band and the wide frequency coverage of the N78 frequency band (from 3300 MHz to 4100 MHz).

As illustrated in FIG. 42, based on the antenna form shown in FIG. 41, the radiator 10 supports the sixth resonance mode f, the seventh resonance mode g, the eighth resonance mode h, and the ninth resonance mode i under the excitation of the third feed system 40.

A current of the sixth resonance mode f is at least distributed between the second coupling end 121 of the second radiator 12 and the second grounding end 122. The current (referred to as the sixth resonant current in the present disclosure) corresponding to the sixth resonance mode f generated by the third feed system 40 exciting the radiator 10 is mainly distributed between the second coupling end 121 of the second radiator 12 and the second grounding end 122. The direction of the resonant current is not specifically limited in the present disclosure. The terms “the sixth resonant current is mainly distributed between the second coupling end 121 of the second radiator 12 and the second grounding end 122” mean that the stronger current is distributed between the second coupling end 121 of the second radiator 12 and the second grounding end 122. It is not excluded that a small amount of the first resonant current is distributed on the first radiator 11 due to the coupling effect of the first radiator 11 and the second radiator 12.

The sixth resonance mode f includes a ¼ wavelength mode of the second radiator 12. The sixth resonance mode f includes a ¼ wavelength mode where the sixth resonant current mainly operates from the second coupling end 121 to the second grounding end 122 of the second radiator 12. The ¼ wavelength mode is understood to mean that the effective electrical length from the second coupling end 121 of the second radiator 12 to the second grounding end 122 is approximately ¼ times the medium wavelength (wavelength in the medium) corresponding to the center frequency of the resonance mode. This description is used for understanding terminology, but not limit the length of the second radiator 12. In some embodiments, the resonance mode generated by the third feed system 40 exciting the radiator 10 may also be the higher-order mode where the sixth resonant current mainly operates on the second radiator 12, such as the ½ wavelength mode, the ¾ wavelength mode, etc.

A current of the seventh resonance mode g is at least distributed between the first connection point B2 and the first coupling end 112 and between the second coupling end 121 and the third feed point A3. The current (referred to as a seventh resonant current in the present disclosure) corresponding to the seventh resonance mode g generated by the third feed system 40 exciting the radiator 10 is mainly distributed between the first connection point B2 and the first coupling end 112 and between the second coupling end 121 and the third feed point A3. The direction of the resonant current is not specifically limited in the present disclosure. The terms “the seventh resonant current is mainly distributed between the first connection point B2 and the first coupling end 112 and between the second coupling end 121 and the third feed point A3” mean that the strong current is distributed between the first connection point B2 and the first coupling end 112 and between the second coupling end 121 and the third feed point A3. It is not excluded that a small amount of the seventh resonant current is distributed in other parts of the first radiator 11 and other parts of the second radiator 12.

The seventh resonance mode g includes a ¼ wavelength mode between the first connection point B2 of the first radiator 11 and the first coupling 112. The seventh resonance mode g includes a ¼ wavelength mode where the seventh resonant current mainly operates from the first connection point B2 of the first radiator 11 to the first coupling end 112. The ¼ wavelength mode may be understood to mean that the effective electrical length from the first connection point B2 of the first radiator 11 to the first coupling end 112 is about ¼ times the medium wavelength (wavelength in the medium) corresponding to the center frequency of the resonance mode. This description is used for understanding terminology, but not limit the length from the first connection point B2 of the first radiator 11 to the first coupling end 112. In some embodiments, the resonance mode generated by the third feed system 40 exciting the radiator 10 may also be the higher-order mode where the seventh resonant current mainly operates on the radiator 10, such as the ½ wavelength mode, the ¾ wavelength mode, etc.

A current in the eighth resonance mode h is at least distributed between the second coupling end 121 and the third feed point A3. The current (referred to as an eighth resonant current in the present disclosure) corresponding to the eighth resonance mode h generated by the third feed system 40 exciting the radiator 10 is mainly distributed between the second coupling end 121 of the second radiator 12 to the third feed point A3. The direction of the resonant current is not specifically limited in the present disclosure. The terms “the eighth resonant current is mainly distributed between the second coupling end 121 of the second radiator 12 and the third feed point A3” mean that the stronger current is distributed between the second coupling end 121 of the second radiator 12 and the third feed point A3. It is not excluded that a small amount of the eighth resonant current is distributed at other positions of the first radiator 11 and other positions of the second radiator 12 due to the coupling effect of the first radiator 11 and the second radiator 12.

The eighth resonance mode h includes a ¼ wavelength mode between the second coupling end 121 of the second radiator 12 and the third feed point A3. The eighth resonance mode h includes a ¼ wavelength mode where the eighth resonant current mainly operates from the second coupling end 121 of the second radiator 12 to the third feed point A3. The ¼ wavelength mode may be understood to mean that the effective electrical length from the second coupling end 121 of the second radiator 12 to the third feed point A3 is approximately ¼ times the medium wavelength (wavelength in the medium) corresponding to the center frequency of the resonance mode. This description is used for understanding terminology, but not limit the length from the second coupling end 121 of the second radiator 12 to the third feed point A3. In some embodiments, the resonance mode generated by the third feed system 40 exciting the radiator 10 may also be the higher-order mode where the eighth resonant current mainly operates on the radiator 10, such as the ½ wavelength mode, the ¾ wavelength mode, etc.

A current of the ninth resonance mode i is at least distributed between the second feed point A2 and the first coupling end 112 and between the second coupling end 121 and the third feed point A3. The current (referred to as a ninth resonant current in the present disclosure) corresponding to the ninth resonance mode i generated by the third feed system 40 exciting the radiator 10 is mainly distributed between the second feed point A2 to the first coupling end 112 and between the second coupling end 121 and the third feed point A3. The direction of the resonant current is not specifically limited in the present disclosure. The terms “the ninth resonant current is mainly distributed between the second feed point A2 to the first coupling end 112 and between the second coupling end 121 and the third feed point A3” mean that the stronger current is distributed between the second feed point A2 and the first coupling end 112 and between the second coupling end 121 and the third feed point A3. It is not excluded that a small amount of the ninth resonant current is distributed at other positions of the first radiator 11 and other positions of the second radiator 12.

The ninth resonance mode i includes a ¼ wavelength mode between the second feed point A2 of the first radiator 11 and the first coupling end 112. The ninth resonance mode i includes a mode of ¼ wavelength where the ninth resonant current mainly operates from the second feed point A2 of the first radiator 11 to the first coupling end 112. The ¼ wavelength mode is understood to mean that the effective electrical length from the second feed point A2 of the first radiator 11 to the first coupling end 112 is approximately ¼ times the medium wavelength (wavelength in the medium) corresponding to the center frequency of the resonance mode. This description is used for understanding terminology, but not limit the length from the second feed point A2 of the first radiator 11 to the first coupling end 112. In some embodiments, the resonance mode generated by the third feed system 40 exciting the radiator 10 may also be the higher-order mode where the ninth resonant current mainly operates on the radiator 10, such as the ½ wavelength mode, the ¾ wavelength mode, etc.

The third band-pass circuit 35 is electrically connected to the second feed point A2, and the third band-pass circuit 35 is configured for conducting the mobile communication signal of the third frequency band to the reference ground GND. The first band-pass circuit 23 is electrically connected to the first feed point A1, and the first band-pass circuit 23 is configured for conducting the mobile communication signal of the third frequency band to the reference ground GND. Thus, the mobile communication signal of the third frequency band may pass through the first feed point A1 and the first band-pass circuit 23 to the reference ground GND, and may also pass through the second feed point A2 and the third band-pass circuit 35 to the reference ground GND, so that a ground return path is added. By means of the current path planning for the third electromagnetic wave signal (MHB+UHB frequency band), the third feed system 40 excites the first radiator 11 and the second radiator 12 to generate the sixth resonance mode f, the seventh resonance mode g, the eighth resonance mode h, and the ninth resonance mode i. The third feed system 40 multiplexes the first radiator 11 and the second radiator 12 coupled to each other to generate the above-mentioned three resonance modes. For example, from the seventh resonance mode g and the ninth resonance mode i, it may be seen that the resonant current forms current distribution (or current density distribution) on the first radiator 11 and the second radiator 12, and the four resonance modes are all within the MHB+UHB frequency band to achieve the full coverage of the MHB+UHB frequency band. Two modes are within the UHB frequency band to improve the coverage of the antenna module 100 to the UHB frequency band, thereby achieving the broadband coverage requirement of the N78 frequency band (from 3300 MHz to 4100 MHz).

For the second signal source 31 receiving and transmitting the second electromagnetic wave signal (Wi-Fi 5G frequency band, Wi-Fi 6E frequency band), the third band-pass circuit 35 constitutes the band-stop characteristic of the mobile communication signal of the third frequency band, so as to filter the mobile communication signal of the third frequency band and support the second signal source 31 receiving and transmitting the second electromagnetic wave signal (Wi-Fi 5G frequency band, Wi-Fi 6E frequency band).

The order of the wavelength modes of the sixth resonance mode f, the seventh resonance mode g, the eighth resonance mode h and the ninth resonance mode i is determined according to the length of the radiator 10 where each resonant current mainly operates. From the wavelength modes of the sixth resonance mode f, the seventh resonance mode g, the eighth resonance mode h, and the ninth resonance mode i, it may be seen that the sixth resonance mode f, seventh resonance mode g, eighth resonance mode h, and ninth resonance mode i are all ¼ wavelength mode. The ¼ wavelength mode is also called the basic mode, and the basic mode is the high-efficiency mode, to achieve the high-efficiency and the wide coverage in the MHB+UHB frequency band.

The third band-pass circuit 35 includes one or more resonant elements, and the resonant element is the capacitor or the inductor. The combination of the resonant elements may refer to the combinations in FIG. 11 to FIG. 18. The specific structure of the third band-pass circuit 35 is exemplified below in conjunction with the accompanying drawings. The specific structure of the third band-pass circuit 35 includes but is not limited to the structure in the following embodiments.

In some embodiments, as illustrated in FIG. 43, the third band-pass circuit 35 includes an eleventh capacitor C11, an eighth inductor L8, and a ninth inductor L9. One end of the eleventh capacitor C11 and one end of the ninth inductor L9 are electrically connected to the second feed point A2. The other end of the eleventh capacitor C11 is electrically connected to one end of the eighth inductor L8, and the other end of the eighth inductor L8 and the other end of the ninth inductor L9 are electrically connected to the reference ground GND.

In some embodiments, as illustrated in FIG. 45 and FIG. 46, the third band-pass circuit 35 is electrically connected to the second feed point A2 or electrically connected between the first band-stop circuit 32 and the second band-stop circuit 33. The third band-pass circuit 35 includes a twelfth capacitor C12 and a tenth inductor L10. One end of the twelfth capacitor C12 is electrically connected to the second feed point A2, the other end of the twelfth capacitor C12 is electrically connected to the tenth inductor L10, and the other end of the tenth inductor L10 is electrically connected to the reference ground GND.

In some embodiments, the third band-pass circuit 35 may also be composed of two resonance elements, three resonance elements, four resonance elements, five resonance elements, etc., and the resonance elements are the inductors or the capacitors.

The joint tuning of the first matching circuit M1, the second matching circuit M2, the third matching circuit M3, the first adjusting circuit T1 and the second adjusting circuit T2 may achieve the multi-band wide coverage of LB+MHB+UHB+Wi-Fi 5G+Wi-Fi 6E. The CA/ENDC of LB+MHB+UHB may be ensured, and the resident state of Wi-Fi 5G+Wi-Fi 6E may be maintained. The UHB-N78 double-wave wide-band coverage (from 3300 MHz to 4100 MHz) may be achieved.

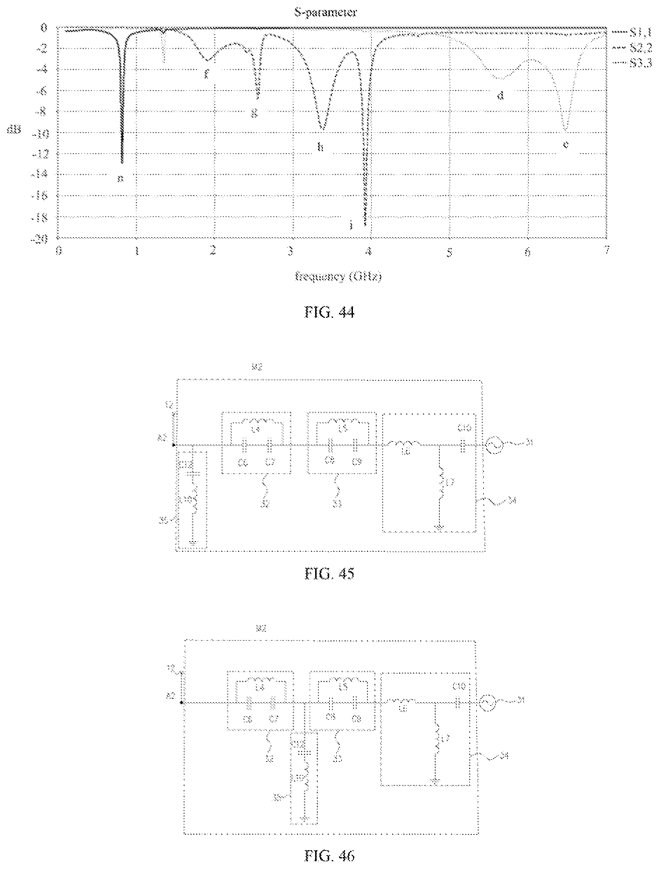

As illustrated in FIG. 44, FIG. 44 is a graph illustrating S parameters of the antenna module 100 provided by the embodiments of the present disclosure in one state. S1,1 is the S parameter curve covering the LB frequency band. S2,2 is the S parameter curve covering the MHB+UHB frequency band. S3,3 is the S parameter curve covering the Wi-Fi 5G and/or Wi-Fi 6E frequency bands. According to S1,1, S2,2 and S3,3, it may be seen that the antenna module 100 provided by the present disclosure has a good coverage breadth in the LB frequency band+MHB frequency band+UHB frequency band+Wi-Fi 5G frequency band+Wi-Fi 6E frequency band.

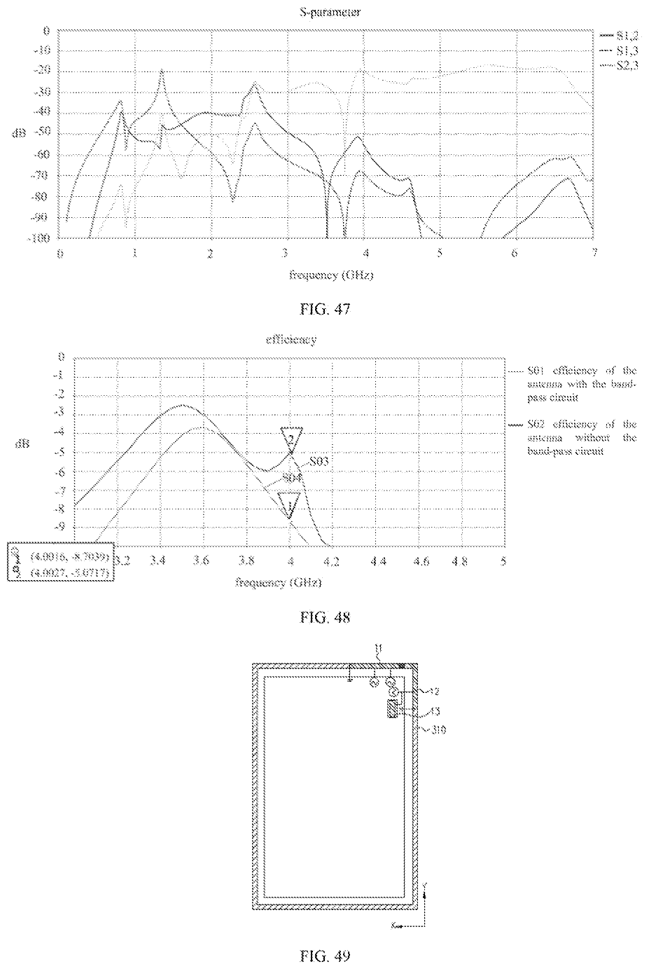

As illustrated in FIG. 47, FIG. 47 is a graph illustrating isolation degrees of the antenna module 100 provided by the embodiments of the present disclosure in one state. Each of S1,2, S1,3, and S2,3 is an isolation degree curve between every two different signal sources. According to FIG. 48, it may be seen that the S parameters between two adjacent signal sources are all below-15 dB, which shows that every two adjacent signal sources have good isolation degree.

As illustrated in FIG. 48, FIG. 48 is an efficiency view of the antenna module 100 provided by the embodiments of the present disclosure. A curve S03 and a curve S04 are the efficiency curves of the antenna module 100 with and without the third band-pass circuit 35, respectively. The antenna module 100 including the third band-pass circuit 35 has two resonances, to increase the bandwidth. At the first point of the curve S03 and the second point of the curve S04, the efficiency is about 4 GHz. The efficiency of the antenna module 100 with the third band-pass circuit 35 at about 4 GHz is greater than that of the antenna module 100 without the third band-pass circuit 35 at about 4 GHz. Moreover, the efficiency of the antenna module 100 with the third band-pass circuit 35 in the frequency band ranging from 3300 MHz to 4100 MHz is greater than that of the antenna module 100 without the third band-pass circuit 35 in the frequency band ranging from 3300 MHz to 4100 MHz. In other words, the band width increases after disposing the third band-pass circuit 35, and the efficiency increases in the frequency band ranging from 3300 MHz to 4100 MHz.

In the antenna module 100 provided by the embodiment of the present disclosure, the first feed system 20, the second feed system 30 and the third feed system 40 are disposed on the first radiator 11 and the second radiator 12 that are coupled to each other. The excitation current of the first feed system 20 forms the high-efficiency fundamental mode on the first radiator 11, so as to transmit and receive the first electromagnetic wave signal. The first matching circuit M1 is disposed, the first band-pass circuit 23 for conducting the third electromagnetic wave signal (MHB+UHB band) is disposed, and the second band-pass circuit 24 for conducting the second electromagnetic wave signal (Wi-Fi 5G frequency band, Wi-Fi 6E frequency band) is disposed. The first band-pass circuit 23 and the second band-pass circuit 24 may be the same circuit. The second matching circuit M2 is disposed, the mobile communication signal for conducting the third frequency band, so that the excitation current of the second feed system 30 flows through the first feed point A1 to the ground. The excitation current of the third feed system 40 flows through the first feed point A1 and the second feed point A2 to the ground, to form the specific current paths. Thus, the first radiator 11 and the second radiator 12 are excited to generate the fourth resonance mode d, the fifth resonance mode e supporting the second electromagnetic wave signal (Wi-Fi 5G frequency band, Wi-Fi 6E frequency band). At the same time, the first radiator 11 and the second radiator 12 are excited to generate the sixth resonance mode f, the seventh resonance mode g, the eighth resonance mode h, and the ninth resonance mode i supporting the third electromagnetic wave signal. The first adjusting circuit T1 and the second adjusting circuit T2 are respectively disposed on the first matching circuit M1 and the third matching circuit M3, so as to achieve multi-frequency-band wide coverage in the LB frequency band+MHB frequency band+UHB frequency band+Wi-Fi 5G frequency band+Wi-Fi 6E frequency band. The multiple modalities may be generated in the UHB-N78 frequency band to meet the requirement of wide-band coverage (from 3300 MHz to 4100 MHz). The common aperture technology is adopted, to improve the space utilization rate of the antenna, effectively save the internal space of the mobile phone, and facilitate better stacking of the whole mobile phone. By the plurality of radiators 10, the multi-mode simultaneous operation is achieved, the bandwidth of the antenna is broadened, and the high isolation degree of each frequency band is achieved through applying different matching circuit forms.

In the present embodiment, the third radiator 13 and the fourth matching circuit M4 may be electrically connected to the third feeding system 40. The specific setting mode may refer to the description of the third radiator 13 and the fourth matching circuit M4 in the antenna module 100 provided by the second embodiment, which may not be repeated here.

The present disclosure provides the electronic device 1000. The electronic device 1000 includes the antenna module 100 of any one of the foregoing embodiments. The antenna module 100 is disposed in the electronic device 1000, and the electronic device 1000 being the mobile phone is taken as an example. The present disclosure does not limit the specific position of the radiator 10 of the antenna module 100 installed in the electronic device 1000. The radiator 10 of the antenna module 100 is integrated into the housing 300, or is located on the surface of the housing 300, or in the space enclosed by the housing 300. The first feed system 20, second feed system 30, and third feed system 40 are installed on the circuit board of electronic device 1000.

The forming modes of the radiator 10 in electronic device 1000 include but are not limited to the following forming modes in the following embodiments.

In some embodiments, at least part of the radiator 10 is integrated with the frame 310 of the housing 300. The housing 300 of the electronic device 1000 has a conductive frame 310 (such as a metal frame 310). At least part of the first radiator 11 of the antenna module 100, and at least part of the second radiator 12 are integrated with the conductive frame 310. For example, the frame 310 is made of a metal material. The radiator 10 is integrated with the frame 310. A coupling gap 113 defined between the radiator 10 is filled with an insulating material. In some embodiments, the radiator 10 may also be integrated with the rear cover 320. In other words, the radiator 10 is integrated into a part of the housing 300.

In some embodiments, the radiator 10 is formed on a surface of the frame 310 (e.g., an inner surface or an outer surface of the frame 310). Basic forms of the radiator 10 include, but are not limited to, a patch radiator 10, forming on the inner surface of the frame 310 by Laser Direct Structuring (LDS), Print Direct Structuring (PDS) and other processes. In the present embodiment, the material of the frame 310 may be non-conductive (non-shielding material for the electromagnetic wave signals, or disposing a wave-transparent structure). The radiator 10 may also be disposed on the surface of the rear cover 320.

In some embodiments, the radiator 10 is disposed on the flexible circuit board, the hard circuit board or other bearing boards. The radiator 10 may be integrated on the flexible circuit board, and the flexible circuit board is stuck on the inner surface of the middle frame 340 through an adhesive, etc. In the present embodiment, the material of a part of the frame 310 corresponding to the radiator 10 may be non-conductive. The radiator 10 may also be disposed on the inner surface of the rear cover 320.

In the present embodiment, as illustrated in FIG. 49, the first radiator 11 is integrated with the metal frame 310. The second radiator 12 is integrated with the metal frame 310. By reusing the space between the first radiator 11, the second radiator 12, and the border 310, the occupied space is reduced. The third radiator 13 of the antenna module 100 is located inside the housing 300. The third radiator 13 of antenna module 100 is a flexible circuit board radiator, a laser directly formed radiator, or a printed radiator, etc. In other words, the third radiator 13 of the antenna module 100 is integrated into the flexible circuit board, directly formed in the housing 300 by laser, or directly formed in the housing 300 by printing, to make the third radiator 13 close to the third feed system 40.

The above description is part of the embodiments of the present disclosure. It should be pointed out that for those skilled in the art, without departing from the principles of the present disclosure, several improvements and refinements may also be made, and these improvements and refinements are also considered as the protection scope of the present disclosure.

What is claimed is:

1. An antenna module, comprising:
a radiator comprising a first radiator and a second radiator, wherein the first radiator comprises a first grounding end, a first coupling end, a first feed point, and a second feed point; the first feed point and the second feed point are disposed between the first grounding end and the first coupling end at an interval, and the first feed point is located between the second feed point and the first grounding end; the second radiator comprises a second coupling end, a second grounding end, and a third feed point between the second coupling end and the second grounding end; and a coupling gap is defined between the first coupling end and the second coupling end, and both the first grounding end and the second grounding end are electrically connected to a reference ground;
a first feed system electrically connected to the first feed point, wherein the first feed system is configured to excite the radiator to receive and transmit a first electromagnetic wave signal, and the first electromagnetic wave signal comprises at least one of a GPS signal and a mobile communication signal of a first frequency band;
a second feed system electrically connected to the second feed point, wherein the second feed system is configured to excite the radiator to receive and transmit a second electromagnetic wave signal, and the second electromagnetic wave signal comprises a Wi-Fi signal; and
a third feed system electrically connected to the third feed point, wherein the third feed system is configured to excite the radiator to receive and transmit a third electromagnetic wave signal, the third electromagnetic wave signal comprises a mobile communication signal of a second frequency band, and a minimum frequency of the second frequency band is greater than a maximum frequency of the first frequency band.

2. The antenna module according to claim 1, wherein the first radiator further comprises a first connection point, the first connection point is located at the first feed point, or the first connection point is located between the first feed point and the second feed point;
the antenna module further comprises a first band-pass circuit, one end of the first band-pass circuit is electrically connected to the first connection point, the other end of the first band-pass circuit is electrically connected to the reference ground, and the first band-pass circuit is configured for conducting the third electromagnetic wave signal to the reference ground.

3. The antenna module according to claim 2, wherein the radiator is configured to support a first resonance mode, a second resonance mode, and a third resonance mode under excitation of the third feed system; a current of the first resonance mode is at least distributed between the second coupling end and the second grounding end; a current of the second resonance mode is at least distributed between the first connection point and the first coupling end and between the second coupling end and the third feed point; and a current of the third resonance mode is at least distributed between the second coupling end and the third feed point; and/or
the first radiator further comprises a second connection point, the second connection point is located at the first feed point, or the second connection point is located between the first feed point and the second feed point; the antenna module further comprises a second band-pass circuit, one end of the second band-pass circuit is electrically connected to the second connection point, the other end of the second band-pass circuit is electrically connected to the reference ground, and the second band-pass circuit is configured for conducting the second electromagnetic wave signal to the reference ground.

4. The antenna module according to claim 3, wherein the first resonance mode comprises a ¼ wavelength mode of the second radiator, the second resonance mode comprises a ¼ wavelength mode between the first connection point of the first radiator and the first coupling end, and the third resonance mode comprises a ¼ wavelength mode between the second coupling end of the second radiator and the third feed point.

5. The antenna module according to claim 3, wherein the radiator is configured to support a fourth resonance mode and a fifth resonance mode under excitation of the second feed system, a current of the fourth resonance mode is at least distributed between the second feed point and the first coupling end, and a current of the fifth resonance mode is at least distributed between the second feed point and the second grounding end.

6. The antenna module according to claim 5, wherein the fourth resonance mode comprises a ¼ wavelength mode between the second feed point of the first radiator and the first coupling end, and the fifth resonance mode comprises a ¾ wavelength mode of the second radiator.

7. The antenna module according to claim 3, the first connection point and the second connection point are a same point, and the first band-pass circuit and the second band-pass circuit are a same circuit; and/or
at least one of the first band-pass circuit and the second band-pass circuit comprises a first capacitor and a first inductor, one end of the first capacitor is electrically connected to the first feed point, the other end of the first capacitor is electrically connected to one end of the first inductor, and the other end of the first inductor is electrically connected to the reference ground; and/or
the first feed system comprises a first matching circuit and a first signal source electrically connected to one end of the first matching circuit, the other end of the first matching circuit is electrically connected to the first feed point, and at least one of the first band-pass circuit and the second band-pass circuit is a part of the first matching circuit.

8. The antenna module according to claim 7, wherein the antenna module further comprises a first adjusting circuit, one end of the first adjusting circuit is electrically connected to the first radiator, and the other end of the first adjusting circuit is electrically connected to the reference ground; the first adjusting circuit comprises at least one of a variable capacitor and a plurality of switch selection circuits; the switch selection circuit comprises at least one of a combination of a switch and an inductor, a combination of the switch and a capacitor, a combination of the switch, the inductor, and the capacitor; the first adjusting circuit is configured to adjust a frequency band of the first electromagnetic wave signal; and one end of the first adjusting circuit is electrically connected to the first feed point, and the first adjusting circuit is a part of the first matching circuit; and/or
the first matching circuit further comprises a first tuning circuit, one end of the first tuning circuit is electrically connected to the first feed point, the other end of the first tuning circuit is electrically connected to the first signal source, and the first tuning circuit is configured for tuning the first electromagnetic wave signal.

9. The antenna module according to claim 8, wherein the first tuning circuit comprises a second capacitor, a third capacitor, a fourth capacitor, a fifth capacitor, a second inductor, and a third inductor; one end of the second capacitor is electrically connected to the first feed point, and the other end of the second capacitor is electrically connected to one end of the third capacitor; the other end of the third capacitor is electrically connected to one end of the fourth capacitor, one end of the second inductor, and one end of the third inductor; the other end of the fourth capacitor is electrically connected to the reference ground, and the other end of the second inductor is electrically connected to the reference ground; and the other end of the third inductor is electrically connected to the first signal source and one end of the fifth capacitor, and the other end of the fifth capacitor is electrically connected to the reference ground.

10. The antenna module according to claim 1, wherein the second feed system comprises a second matching circuit and a second signal source electrically connected to one end of the second matching circuit, and the other end of the second matching circuit is electrically connected to the second feed point; the second matching circuit further comprises a first band-stop circuit, a second band-stop circuit, and a second tuning circuit that are sequentially connected between the second feed point and the second signal source; the first band-stop circuit is configured for filtering the first electromagnetic wave signal, the second band-stop circuit is configured for filtering the third electromagnetic wave signal, and the second tuning circuit is configured for tuning the second electromagnetic wave signal.

11. The antenna module according to claim 10, wherein the first band-stop circuit comprises a sixth capacitor, a seventh capacitor, and a fourth inductor; one end of the sixth capacitor and one end of the fourth inductor are electrically connected to the second feed point, and the other end of the sixth capacitor is electrically connected to one end of the seventh capacitor; and the other end of the fourth inductor is electrically connected to the other end of the seventh capacitor and one end of the second band-stop circuit; and/or,
the second band-stop circuit comprises an eighth capacitor, a ninth capacitor, and a fifth inductor; one end of the eighth capacitor and one end of the fifth inductor are electrically connected to the first band-stop circuit, and the other end of the eighth capacitor is electrically connected to one end of the ninth capacitor; and the other end of the fifth inductor is electrically connected to the other end of the ninth capacitor and one end of the second tuning circuit; and/or, the second tuning circuit comprises a sixth inductor, a seventh inductor, and a tenth capacitor;
one end of the sixth inductor is electrically connected to the other end of the second band-stop circuit, and the other end of the sixth inductor is electrically connected to one end of the seventh inductor and one end of the tenth capacitor; and the other end of the seventh inductor is electrically connected to the reference ground, and the other end of the tenth capacitor is electrically connected to the second signal source.

12. The antenna module according to claim 10, wherein the third electromagnetic wave signal comprises a mobile communication signal of a third frequency band, and the third frequency band is within a UHB frequency band range;
the second matching circuit further comprises a third band-pass circuit, one end of the third band-pass circuit is electrically connected to the second feed point or between the first band-pass circuit and the second band-pass circuit, and the other end of the third band-pass circuit is electrically connected to the reference ground; and the third band-pass circuit is configured for conducting the mobile communication signal of the third frequency band to the reference ground.

13. The antenna module according to claim 12, wherein the third frequency band comprises a N78 frequency band; and/or
the radiator is configured to support a sixth resonance mode, a seventh resonance mode, an eighth resonance mode, and a ninth resonance mode under excitation of the third feed system; a current of the sixth resonance mode is at least distributed between the second coupling end and the second grounding end; a current of the seventh resonance mode is at least distributed between the first connection point and the first coupling end and between the second coupling end and the third feed point; a current of the eighth resonance mode is at least distributed between the second coupling end and the third feed point; and a current of the ninth resonance mode is at least distributed between the second feed point and the first coupling end and between the second coupling end and the third feed point; and/or
the third band-pass circuit comprises an eleventh capacitor, an eighth inductor, and a ninth inductor; one end of the eleventh capacitor and one end of the ninth inductor are electrically connected to the second feed point, and the other end of the eleventh capacitor is electrically connected to one end of the eighth inductor; and the other end of the eighth inductor and the other end of the ninth inductor are electrically connected to the reference ground; or
the third band-pass circuit comprises a twelfth capacitor and a tenth inductor, one end of the twelfth capacitor is electrically connected to the second feed point, the other end of the twelfth capacitor is electrically connected to the tenth inductor, and the other end of the tenth inductor is electrically connected to the reference ground.

14. The antenna module according to claim 13, wherein the sixth resonance mode comprises a ¼ wavelength mode of the second radiator, the seventh resonance mode comprises a ¼ wavelength mode between the first connection point of the first radiator and the first coupling end, the eighth resonance mode comprises a ¼ wavelength mode between the second coupling end of the second radiator and the third feed point, the ninth resonance mode comprises a ¼ wavelength mode between the second feed point of the first radiator and the first coupling end.

15. The antenna module according to claim 1, wherein the third feed system comprises a third matching circuit and a third signal source electrically connected to one end of the third matching circuit, and the other end of the third matching circuit is electrically connected to the third feed point.

16. The antenna module according to claim 15, wherein the third matching circuit comprises an eleventh inductor, a twelfth inductor, a thirteenth inductor, a thirteenth capacitor, a fourteenth capacitor, a fifteenth capacitor, and a sixteenth capacitor; one end of the eleventh inductor is electrically connected to the third feed point, and the other end of the eleventh inductor is electrically connected to one end of the twelfth inductor, one end of the thirteenth capacitor and one end of the fourteenth capacitor; the other end of the twelfth inductor and the other end of the thirteenth capacitor are electrically connected to the reference ground; the other end of the fourteenth capacitor is electrically connected to one end of the fifteenth capacitor, and the other end of the fifteenth capacitor is electrically connected to one end of the thirteenth inductor and one end of the third signal source; and the other end of the thirteenth inductor is electrically connected to one end of the sixteenth capacitor, and the other end of the sixteenth capacitor is electrically connected to the reference ground; and/or
the antenna module further comprises a second adjusting circuit, wherein one end of the second adjusting circuit is electrically connected to the reference ground, and the other end of second adjusting circuit is electrically connected to the second radiator or the third matching circuit; and the second adjusting circuit is configured for adjusting the frequency band of the third electromagnetic wave signal; and/or
the antenna module further comprises a third radiator electrically connected to the third matching circuit, wherein the third radiator is a flexible circuit board radiator, a laser direct molding radiator, or a printing radiator; and the third radiator is configured for transmitting and receiving a fourth electromagnetic wave signal under excitation of the third feed system, and the fourth electromagnetic wave signal comprises a UHB frequency band.

17. The antenna module according to claim 16, further comprising a fourth matching circuit, wherein one end of the fourth matching circuit is electrically connected between the third matching circuit and the third signal source, and the other end of the fourth matching circuit is connected to the third radiator.

18. The antenna module according to claim 17, wherein the fourth matching circuit comprises a seventeenth capacitor, one end of the seventeenth capacitor is electrically connected to the third signal source, and the other end of the seventeenth capacitor is electrically connected to the third radiator; or
the fourth matching circuit comprises a seventeenth capacitor and an eighteenth capacitor, one end of the seventeenth capacitor is electrically connected to the third signal source, the other end of the seventeenth capacitor is electrically connected to the third radiator and one end of the eighteenth capacitor, and the other end of the eighteenth capacitor is electrically connected to the reference ground; or
the fourth matching circuit comprises a seventeenth capacitor and a fourteenth inductor, one end of the seventeenth capacitor is electrically connected to the third signal source, the other end of the seventeenth capacitor is electrically connected to the third radiator and one end of the fourteenth inductor, and the other end of the fourteenth inductor is electrically connected to the reference ground.

19. The antenna module according to claim 1, wherein the first electromagnetic wave signal comprises at least one of a GPS-L5 signal and a mobile communication signal with a frequency less than 1000 MHz, and the second electromagnetic wave signal comprises a Wi-Fi 5G signal and/or a Wi-Fi 6E signal; and the third electromagnetic wave signal comprises a mobile communication signal with a frequency greater than or equal to 1000 MHz and less than or equal to 6000 MHz, and the mobile communication signal comprises at least one of a 4G mobile communication signal and a 5G mobile communication signal.

20. An electronic device, comprising:
an antenna module, comprising:
a radiator comprising a first radiator and a second radiator, wherein the first radiator comprises a first grounding end, a first coupling end, a first feed point, and a second feed point; the first feed point and the second feed point are disposed between the first grounding end and the first coupling end at an interval, and the first feed point is located between the second feed point and the first grounding end; the second radiator comprises a second coupling end, a second grounding end, and a third feed point between the second coupling end and the second grounding end; and a coupling gap is defined between the first coupling end and the second coupling end, and both the first grounding end and the second grounding end are electrically connected to a reference ground;
a first feed system electrically connected to the first feed point, wherein the first feed system is configured to excite the radiator to receive and transmit a first electromagnetic wave signal, and the first electromagnetic wave signal comprises at least one of a GPS signal and a mobile communication signal of a first frequency band;
a second feed system electrically connected to the second feed point, wherein the second feed system is configured to excite the radiator to receive and transmit a second electromagnetic wave signal, and the second electromagnetic wave signal comprises a Wi-Fi signal; and
a third feed system electrically connected to the third feed point, wherein the third feed system is configured to excite the radiator to receive and transmit a third electromagnetic wave signal, the third electromagnetic wave signal comprises a mobile communication signal of a second frequency band, and a minimum frequency of the second frequency band is greater than a maximum frequency of the first frequency band.
